(19) United States
(12) Patent Application Publication
(10) Pub. No.: US 2025/0189801 A1
(43) Pub. Date: Jun. 12, 2025

(54) Wearable Heads Up Displays

(71) Applicant: DigiLens Inc., Sunnyvale, CA (US)

(72) Inventors: Jonathan David Waldern, Diablo, CA (US); Milan Momcilo Popovich, Leicester (GB); Alastair John Grant, San Jose, CA (US)

(21) Appl. No.: 19/056,523

(22) Filed: Feb. 18, 2025

Related U.S. Application Data
(63) Continuation of application No. 18/171,117, filed on Feb. 17, 2023, now Pat. No. 12,248,150.
Application No. 18/171,117 is a continuation of application No. 17/457,891, filed on Dec. 6, 2021, now Pat. No. 11,586,046.
Application No. 17/457,891 is a continuation of application No. 17/118,316, filed on Dec. 10, 2020, now Pat. No. 11,194,162.
Application No. 17/118,316 is a continuation of application No. 16/773,585, filed on Jan. 27, 2020, now abandoned.
Application No. 16/773,585 is a continuation of application No. 15/863,798, filed on Jan. 5, 2018, now Pat. No. 10,545,346.
(60) Provisional application No. 62/498,715, filed on Jan. 5, 2017.

(51) Int. Cl. G02B 27/01; G02B 27/00; G06F 3/042; G06F 3/043

(52) U.S. Cl. CPC G02B 27/0172; G02B 27/0093; G02B 27/0176; G06F 3/0421; G06F 3/0433; G06F 3/0436; G02B 2027/0125; G02B 2027/0169; G02B 2027/0174; G02B 2027/0187

(57) ABSTRACT

An optical display, including a first waveguide having a first set of surfaces, an input grating, a fold grating, and an output grating; an image input image node assembly; and a prismatic relay optics is provided. The prismatic relay optics may be configured to be optomechanically connected to the waveguide and the input image node assembly. The optical display is may also be configured to operate alone or as integrated with a headpiece to be used as a HUD. The HUD may have a first and a second configuration wherein the waveguide is decoupled or coupled.

### CROSS-REFERENCE TO RELATED APPLICATIONS

The present application is a continuation of U.S. patent application Ser. No. 18/171,117, entitled “Wearable Heads Up Displays” to Waldern et al., filed Feb. 17, 2023, which is a continuation of U.S. patent application Ser. No. 17/457,891, entitled “Wearable Heads Up Displays” to Waldern et al., filed Dec. 6, 2021, which application is a continuation of U.S. patent application Ser. No. 17/118,316, entitled “Wearable Heads Up Displays” to Waldern et al., filed Dec. 10, 2020, which application is a continuation of U.S. patent application Ser. No. 16/773,585, entitled “Wearable Heads Up Displays” to Waldern et al., filed Jan. 27, 2020, which application is a continuation of U.S. patent application Ser. No. 15/863,798, entitled “Wearable Heads Up Displays” to Waldern et al., filed Jan. 5, 2018, which application claims priority to U.S. Provisional Patent Application No. 62/498,715, entitled “Waveguide Displays” to Waldern et al., filed Jan. 5, 2017, the disclosures of which are incorporated herein by reference in their entireties.

### FIELD OF THE INVENTION

The present invention relates generally to displays including but not limited to near eye displays and more specifically holographic waveguide displays. Additionally, the present invention deals directly with the application of such displays in protective helmets.

### BACKGROUND

Waveguide optics is currently being considered for a range of display and sensor applications for which the ability of waveguides to integrate multiple optical functions into a thin, transparent, lightweight substrate is of key importance. This new approach is stimulating new product developments including near-eye displays for Augmented Reality (AR) and Virtual Reality (VR), compact Heads Up Display (HUDs) for aviation and road transport and sensors for biometric and laser radar (LIDAR) applications. Waveguide displays have been proposed which use diffraction gratings to preserve eye box size while reducing lens size. U.S. Pat. No. 4,309,070 issued to St. Leger Searle and U.S. Pat. No. 4,711,512 issued to Upatnieks disclose substrate waveguide head up displays where the pupil of a collimating optical system is effectively expanded by the waveguide structure. U.S. patent application Ser. No. 13/869,866 discloses holographic wide angle displays and U.S. patent application Ser. No. 13/844,456 discloses waveguide displays having an upper and lower field of view.

A common requirement in waveguide optics is to provide beam expansion in two orthogonal directions. In display applications this translates to a large eyebox. While the principles of beam expansion in holographic waveguides are well established dual axis expansion requires separate grating layers to provide separate vertical and horizontal expansion. One of the gratings, usually the one giving the second axis expansion, also provides the near eye component of the display where the high transparency and thin, lightweight form factor of a diffractive optics can be used to maximum effect. In practical display applications, which demand full color and large fields of view the number of layers required to implement dual axis expansion becomes unacceptably large resulting in increased thickness weight and haze. Solutions for reducing the number of layers based on multiplexing two or more gratings in a single layer or fold gratings which can perform dual axis expansion (for a given angular range and wavelength) in a single layer are currently in development. Dual axis expansion is also an issue in waveguides for sensor applications such as eye trackers and LIDAR. There is a requirement for a low cost, efficient, compact dual axis expansion waveguide.

The use of HUD's in the motor industry is increasing in popularity especially in the motorcycle and recreational sport vehicle industry. Such industry applications enable the user to maintain focus on the road or surrounding environment while also receiving information about the users speed, engine conditions, phone calls, and possibly other extrinsic information that would otherwise divert the user's attention through the use of other external devices. The application of such displays is becoming essential for increased safety of the user and as a whole.

### SUMMARY OF THE INVENTION

An optical display HUD is disclosed. In one embodiment an optical display, comprises a first waveguide having a first set of surfaces comprising a first open space disposed therebetween; at least one input grating disposed between the first set of surfaces and configured to receive an image from an Input Image Node assembly; at least one fold grating optically connected to the at least one input grating and disposed between the first set of surfaces; at least one output grating optically connected to the at least one fold grating and disposed between the first set of surfaces; a prismatic relay optics opto-mechanically disposed between the input image node assembly and the first waveguide; an opto-mechanical coupler disposed between the prismatic relay optics and the input image node assembly, wherein the first opto-mechanical coupler is configured to support the prismatic relay optics and receive a collimated first wavelength image modulated light and to cause the light to travel within the prismatic relay optics via total internal reflections to the first waveguide; and an optical interface coupler disposed between the prismatic relay optics and the first waveguide wherein the optical interface coupler is configured to receive the wavelength image modulated light as reflected within the prismatic relay optics and optically communicate said image to the first waveguide wherein the image will be reflected within the first waveguide via total internal reflection between said first set of surfaces from the at least one input grating to the fold grating; wherein said fold grating is configured to provide pupil expansion in a first direction and to direct said light to the output grating via total internal reflection between the first set of surfaces; and wherein said output grating is configured to provide pupil expansion in a second direction different than said first direction and to cause said light to exit said first waveguide from said first set of surfaces.

In other embodiments the input image node assembly further comprises an outer body having a thickness and an internal cavity wherein disposed within the cavity is at least one light source and at least one microdisplay panel for displaying image pixels and collimation optics, and wherein the input image node assembly is configured to project an image displayed on said microdisplay panel within the prismatic relay optics at a critical angle unique thereby ensuring the image is transmitted to the waveguide at the critical angle thus preserving the total internal reflection of the image.

In still other embodiments gratings of the optical display are switchable between a diffracting and non-diffracting state.

In yet other embodiments the optical display further comprises a second waveguide comprising a second set of surfaces having a second open space there between and, an input grating, a fold grating, and an output grating, wherein the input coupler is configured to receive a second wavelength light from the input image node assembly.

In yet still other embodiments the gratings comprised of a liquid crystal-based grating.

In even still other embodiments the optical display further comprises an eye tracker.

In other embodiments the optical display further comprises a dynamic focus lens disposed within the Input image node assembly.

In still other embodiments the optical display further comprises a dynamic focus lens disposed in proximity to the first set of surfaces of the first waveguide.

In yet still other embodiments the opto-mechanical coupler and the optical interface coupler are configured to be coupled or decoupled via at least one mechanical interface wherein the at least one mechanical interface of the opto-mechanical coupler is disposed between the opto-mechanical coupler and the input image node assembly and the at least one mechanical interface of the optical interface coupler is disposed between the optical interface coupler and the prismatic relay optics.

In yet still other embodiments the at least one mechanical interface of each of the opto-mechanical coupler and optical interface coupler is selected from a group consisting of hinged and magnetic.

In even still other embodiments the first waveguide is disposable.

In other embodiments the first set of surfaces are a ballistic shatter proof polymer.

In still other embodiments the first set of surfaces are planar surfaces.

In yet still other embodiments the first set of surfaces are curved.

In yet other embodiments the input image node assembly further comprises a laser scanner.

In even other embodiments the display is further configured to be removably connected to a headpiece.

In yet even other embodiments the input image node assembly is further configured to be adjustably connected to the headpiece such that the waveguide may be optimally adjusted and wherein the waveguide may be decoupled for replacement or storage.

In other embodiments the input image node assembly is configured to be integrated within an internal protection material of a helmet.

In yet other embodiments the input image node assembly is further configured to be adjustable such that the waveguide may be optimally adjusted.

In still other embodiments the waveguide is configured to be adjustable such that the rake angle may be optimally adjusted.

In yet still other embodiments the headpiece is configured to be inserted into a helmet.

In even other embodiments the input image node assembly is further configured to removably connect to a helmet having at least an outer shell and at least an internal protection material and an electromechanical connection assembly disposed within the helmet either connected to the outer shell or integrated within the internal protection material and where the input image node assembly is electromechanically connected to the helmet.

In even still other embodiments the input image node assembly further comprises HDMI and power connections disposed therein wherein the HDMI and power connections are configured to connect to an equivalent connection in the electromechanical connection assembly disposed within the helmet.

In other embodiments at least one of said input coupler, fold grating and output grating multiplexes at least one of color or angle.

In yet other embodiments the optical display further comprises a beam homogenizer

In still other embodiments the display includes at least one optical traversing a gradient index image transfer waveguide.

In yet still other embodiments the optical display further comprises a dichroic filter disposed between the input grating regions of said first and second waveguides.

In even other embodiments the input image node assembly further comprises a spatially-varying numerical aperture component for providing a numerical aperture variation along a direction corresponding to the field of view coordinate diffracted by said input coupler.

In even still other embodiments the spatially-varying numerical aperture component has at least one of diffractive, birefringent, refracting or scattering characteristics.

In other embodiments the field of view coordinate is the horizontal field of view of the display.

In yet other embodiments a spatially varying-numerical aperture is provided by tilting a stop plane such that its normal vector is aligned parallel to the highest display field angle in the plane containing the field of view coordinate diffracted by said input coupler.

In still other embodiments the at least one of said input coupler, said fold grating or said output grating is a rolled k-vector grating.

In yet still other embodiments the thickness of the outer body of the IIN does not exceed 2 mm.

In even other embodiments the input image node assembly further comprises a cooling fan configured to move ambient air from outside the input image node assembly through the internal components of the assembly thereby maintaining an optimum temperature of the input image node assembly.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a schematic cross section view of a waveguide display in one embodiment.

FIG. 2 is a schematic plan view of a waveguide display shown the disposition of the gratings in one grating layer in one embodiment.

FIG. 3 is a schematic plan view of a waveguide display shown the disposition of the gratings in two grating layers in one embodiment.

FIG. 4 is a schematic cross section view of a color waveguide display using one waveguide per color and two grating layers in each waveguide in one embodiment.

FIG. 5 is a schematic cross section view of a color waveguide display using one waveguide per color and one grating layer in each waveguide in one embodiment.

FIG. 6 is a cross section view of an eye tracked near eye display according to the principles of the invention in one embodiment.

FIG. 7 is a cross section view of an eye tracked near eye display incorporating a dynamic focus lens in one embodiment.

FIG. 8 is a cross section view of an eye tracked near eye display incorporating a dynamic focus lens in one embodiment.

FIG. 9 is a schematic cross section view of a reflective microdisplay input image node containing a spatially-varying numerical aperture component in one embodiment.

FIG. 10 is a schematic cross section view of a spatially-varying numerical aperture component based on a wedge prism in one embodiment.

FIG. 11is a schematic cross section view of a spatially-varying numerical aperture component based on a wedge prism with one curved surface in one embodiment.

FIG. 12 is a schematic cross section view of a spatially-varying numerical aperture component based on an array of prisms in one embodiment.

FIG. 13is a schematic cross section view of a spatially-varying numerical aperture component based on an array of lenses in one embodiment.

FIG. 14A is a schematic cross section view of a spatially-varying numerical aperture component based on an array of scattering elements in one embodiment.

FIG. 14B is a schematic cross section view of a spatially-varying numerical aperture component based on a substrate with a continuously varying scattering function in one embodiment.

FIG. 14C is a schematic cross section view of a spatially-varying numerical aperture component based on a substrate with a continuously varying birefringence tensor in one embodiment.

FIG. 14D is a schematic cross section view of a spatially-varying numerical aperture component based on an array of grating elements in one embodiment

FIG. 15 is a schematic cross section view of an optical arrangement for providing varying numerical aperture across a pupil using a tilted pupil plane in one embodiment.

FIG. 16A is a front view of a waveguide component showing the input, fold and output gratings in one embodiment.

FIG. 16B is a front view of a waveguide component showing the input, fold and output gratings in one embodiment.

FIG. 17 is a front view of a waveguide component showing the input, fold and output gratings in one embodiment.

FIG. 18A is a schematic plan view of a first operational state display comprising a waveguide that can be decoupled from the IIN in one embodiment.

FIG. 18B is a schematic plan view of a second operational state where the waveguide is decoupled from the IIN.

FIG. 19A is a three-dimensional view of a first operational state of a wearable display comprising a retractable waveguide in one embodiment.

FIG. 19B is a three-dimensional view of a second operational state of a wearable display comprising a retractable waveguide in one embodiment.

FIG. 19C is a three-dimensional view of a third operational state of a wearable display comprising a retractable waveguide in one embodiment.

FIG. 20A is a front view of a waveguide display eyepiece in one embodiment.

FIG. 20B is a plan view of a waveguide display eyepiece in one embodiment.

FIG. 20C is a side view of a waveguide display eyepiece in one embodiment.

FIG. 20D is a three-dimensional view of a waveguide display eyepiece in one embodiment.

FIG. 21A is a three-dimensional view of a waveguide display implemented in a motorcycle helmet in one embodiment.

FIG. 21B is a three-dimensional view of a waveguide display implemented in a motorcycle helmet in one embodiment.

FIG. 22 is a three-dimensional view of a near eye display showing a ray trace from the IIN and waveguide component up to the eye box in one embodiment. FIG. 11A is a rolled K-vector grating providing stepwise changes in K-vector direction in one embodiment.

FIG. 23A is a three-dimensional view of a first operational state of a motorcycle display in one embodiment.

FIG. 23B is a three-dimensional view of a second operational state of a motorcycle display in one embodiment.

FIG. 24 is a schematic plan view of a transparent wearable display including prismatic relay optics for providing enhance peripheral external field of view in one embodiment.

FIG. 25 is a table providing a specification for a motorcycle helmet HUD in one exemplary embodiment.

FIG. 26A is a schematic front elevation view of a motorcycle helmet HUD in one exemplary embodiment.

FIG. 26B is a schematic side elevation view of a motorcycle helmet HUD in one exemplary embodiment.

FIG. 27 is a detail of a motorcycle helmet HUD in one exemplary embodiment.

FIG. 28 is a detail of a motorcycle helmet HUD in one exemplary embodiment.

FIG. 29 is a detail of a motorcycle helmet HUD in one exemplary embodiment.

FIG. 30 is a three-quarter view of a motorcycle helmet HUD in one exemplary embodiment.

FIG. 31 is a plan view of a motorcycle helmet HUD in one exemplary embodiment.

FIG. 32 is a three-quarter view of a motorcycle helmet HUD in one exemplary embodiment.

FIG. 33 is a detail of a motorcycle helmet HUD in one exemplary embodiment.

FIG. 34 is a detail of a motorcycle helmet HUD in one exemplary embodiment.

FIG. 35 is a detail of a motorcycle helmet HUD in one exemplary embodiment.

FIG. 36 is a detail of a motorcycle helmet HUD in one exemplary embodiment.

FIG. 37 is a detail of a motorcycle helmet HUD in one exemplary embodiment.

FIG. 38 is a plan view of a motorcycle helmet HUD in one exemplary embodiment.

FIG. 39 is an overhead view of a motorcycle helmet HUD in one exemplary embodiment.

FIG. 40A illustrates a detail of the mechanism for attaching the waveguide eyepiece to the IIN in one embodiment.

FIG. 40B illustrates a detail of the mechanism for attaching the waveguide eyepiece to the IIN in one embodiment.

FIG. 40C illustrates a detail of the mechanism for attaching the waveguide eyepiece to the IIN in one embodiment.

FIG. 40D illustrates a detail of the mechanism for attaching the waveguide eyepiece to the IIN in one embodiment.

FIG. 40E illustrates a detail of the mechanism for attaching the waveguide eyepiece to the IIN in one embodiment.

FIG. 40F illustrates a detail of the mechanism for attaching the waveguide eyepiece to the IIN in one embodiment.

FIG. 41A illustrates a detail of the basic helmet integration of one embodiment

FIG. 41B illustrates the optical path of the image produced from the IIN.

FIG. 42A illustrates one embodiment of the IIN.

FIG. 42B Illustrates an embodiment of the opto-mechanical connection between the IIN and the prismatic relay.

FIG. 43A illustrates another view of the opto-mechanical connection between the IIN and prismatic relay.

FIG. 43B illustrates another view of the opto-mechanical connection between the IIN and prismatic relay.

FIG. 44A illustrates one embodiment of the HUD connection to a helmet

FIG. 44B illustrates an alternate view of the HUD connection to a helmet as well as one embodiment of the internal components of the IIN.

FIG. 45 illustrates a method of attachment in accordance with some embodiments.

FIG. 46 illustrates top and orthogonal views of the positioning of the waveguide with respect to corrective lenses.

FIG. 47A illustrates an alternate view of the HUD placement in a helmet in spacial relation to the wearer's corrective lenses.

FIG. 47B illustrates an alternate view of the HUD placement in a helmet in spacial relation to the wearer's corrective lenses.

FIG. 48 illustrates the mechanism by which the HUD connects to a bracket in accordance with some embodiments.

FIG. 49A illustrated one embodiment of the internal configuration of the IIN.

FIG. 49B illustrates an alternate view of the HUD and various components.

FIG. 50A illustrates an embodiment of the HUD integrated with a helmet.

FIG. 50B Illustrates an embodiment of the HUD configuration.

FIG. 51 illustrates various components of the HUD/Helmet configuration.

FIG. 52 is a schematic view of a waveguide display with a correction element for compensating for windscreen curvature distortion in one embodiment.

### DETAILED DESCRIPTION

Referring generally to the Figures, systems and methods relating to near-eye display or head up display systems are provided according to various embodiments. Holographic waveguide technology can be utilized in waveguides for helmet mounted displays or head mounted displays (HMDs) and head up displays (HUDs) for many applications, including military applications and consumer applications (e.g., augmented reality glasses, etc.). Switchable Bragg gratings (SBGs) may be used in waveguides to eliminate extra layers and to reduce the thickness of current display systems, including HMDs, HUDs, and other near eye displays and to increase the field of view by tiling images presented sequentially on a microdisplay. A larger exit pupil may be created by using fold gratings in conjunction with conventional gratings to provide pupil expansion on a single waveguide in both the horizontal and vertical directions. Using the systems and methods disclosed herein, a single optical waveguide substrate may generate a wider field of view than found in current waveguide systems. Diffraction gratings may be used to split and diffract light rays into several beams that travel in different directions, thereby dispersing the light rays.

In various embodiments, the grating used in the invention is a Bragg grating (also referred to as a volume grating). Bragg gratings have high efficiency with little light being diffracted into higher orders. The relative amount of light in the diffracted and zero order can be varied by controlling their refractive index modulation of the grating, a property which is used to make lossy waveguide gratings for extracting light over a large pupil. One class of gratings is known as Switchable Bragg Gratings (SBG). SBGs are fabricated by first placing a thin film of a mixture of photopolymerizable monomers and liquid crystal material between parallel glass plates. One or both glass plates support electrodes, typically transparent indium tin oxide films, for applying an electric field across the film. A volume phase grating is then recorded by illuminating the liquid material (often referred to as the syrup) with two mutually coherent laser beams, which interfere to form a slanted fringe grating structure. During the recording process, the monomers polymerize and the mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the film. When an electric field is applied to the grating via transparent electrodes, the natural orientation of the LC droplets is changed causing the refractive index modulation of the fringes to reduce and the hologram diffraction efficiency to drop to very low levels. Typically, SBG Elements are switched clear in 30 μs. With a longer relaxation time to switch ON. Note that the diffraction efficiency of the device can be adjusted, by means of the applied voltage, over a continuous range. The device exhibits near 100% efficiency with no voltage applied and essentially zero efficiency with a sufficiently high voltage applied. In certain types of HPDLC devices magnetic fields may be used to control the LC orientation. In certain types of HPDLC phase separation of the LC material from the polymer may be accomplished to such a degree that no discernible droplet structure results. A SBG may also be used as a passive grating. In this mode its chief benefit is a uniquely high refractive index modulation.

SBGs may be used to provide transmission or reflection gratings for free space applications. SBGs may be implemented as waveguide devices in which the HPDLC forms either the waveguide core or an evanescently coupled layer in proximity to the waveguide. The parallel glass plates used to form the HPDLC cell provide a total internal reflection (TIR) light guiding structure. Light is coupled out of the SBG when the switchable grating diffracts the light at an angle beyond the TIR condition. Waveguides are currently of interest in a range of display and sensor applications. Although much of the earlier work on HPDLC has been directed at reflection holograms transmission devices are proving to be much more versatile as optical system building blocks. Typically, the HPDLC used in SBGs comprise liquid crystal (LC), monomers, photoinitiator dyes, and coinitiators. The mixture frequently includes a surfactant. The patent and scientific literature contains many examples of material systems and processes that may be used to fabricate SBGs. Two fundamental patents are: U.S. Pat. No. 5,942,157 by Sutherland, and U.S. Pat. No. 5,751,452 by Tanaka et al. Both filings describe monomer and liquid crystal material combinations suitable for fabricating SBG devices. One of the known attributes of transmission SBGs is that the LC molecules tend to align normal to the grating fringe planes. The effect of the LC molecule alignment is that transmission SBGs efficiently diffract P polarized light (i.e., light with the polarization vector in the plane of incidence) but have nearly zero diffraction efficiency for S polarized light (i.e., light with the polarization vector normal to the plane of incidence. Transmission SBGs may not be used at near-grazing incidence as the diffraction efficiency of any grating for P polarization falls to zero when the included angle between the incident and reflected light is small.

### Waveguide Displays

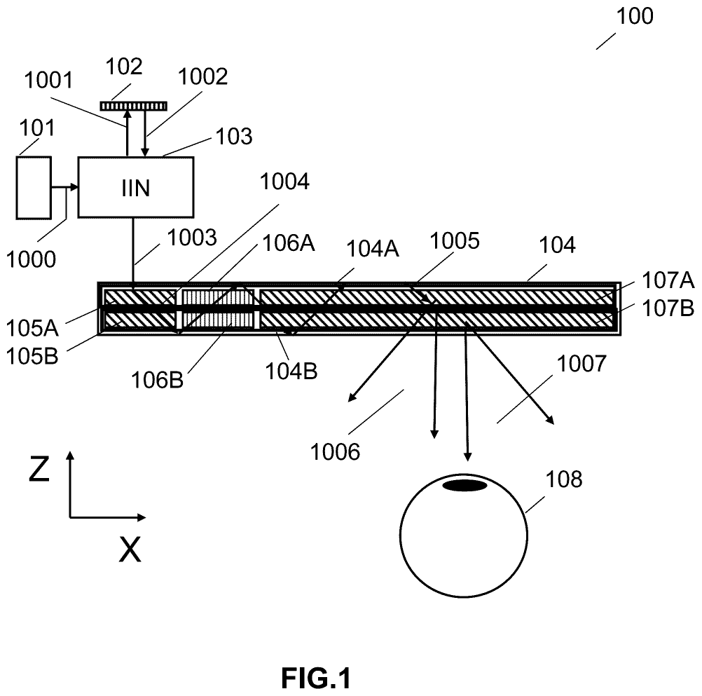

In accordance with various embodiments waveguide displays may take on a variety of configurations. Illustrated in FIG. 1 there is provided a dual axis expansion waveguide display configuration 100 comprising a light source 101 a microdisplay panel 102 and an input image node (IIN) 103 optically coupled to a waveguide 104. In such embodiments, the waveguide may comprise two grating layers 104A, 104B. In some embodiments, the waveguide is formed by sandwiched the grating layers between glass or plastic substrates to form a stack within which total internal reflection occurs at the outer substrate and air interfaces. The stack may further comprise additional layers such as beam splitting coatings and environmental protection layers. Each grating layer may contain an input grating 105A, 105B, a fold grating exit pupil expander 106A, 106B and an output grating 107A, 107B where characters A and B refer to waveguide layers 104A, 104B respectively. The input grating, fold grating and the output grating are holographic gratings, such as a switchable or non-switchable SBG. As used herein, the term grating may encompass a grating comprised of a set of gratings in some embodiments. In general, the IIN 103 integrates a microdisplay panel 102, light source 101 and optical components needed to illuminate the display panel, separate the reflected light and collimate it into the required FOV. The IIN 103 projects the image displayed on the microdisplay panel such that each display pixel is converted into a unique angular direction within the substrate waveguide according to some embodiments. In the embodiment of FIG. 1 and in the embodiments to be described below at least one of the input fold and output gratings may be electrically switchable. In many embodiments, all three grating types are passive, that is, non-switching. The collimation optics contained in the IIN 103 may comprise lens and mirrors which is some embodiments may be diffractive lenses and mirrors.

In some embodiments, the IIN may be based on the embodiments and teachings disclosed in U.S. patent application Ser. No. 13/869,866 entitled HOLOGRAPHIC WIDE ANGLE DISPLAY, and U.S. patent application Ser. No. 13/844,456 entitled TRANSPARENT WAVEGUIDE DISPLAY, the disclosures of which are incorporated herein by reference. In some embodiments, the IIN contains beamsplitter for directing light onto the microdisplay and transmitting the reflected light towards the waveguide. In one embodiment, the beamsplitter is a grating recorded in HPDLC and uses the intrinsic polarization selectivity of such gratings to separate the light illuminating the display and the image modulated light reflected off the display. In some embodiments, the beam splitter is a polarizing beam splitter cube. In some embodiment, the IIN incorporates a despeckler. Advantageously, the despeckler may be a holographic waveguide device based on the embodiments and teachings of U.S. Pat. No. 8,565,560 entitled LASER ILLUMINATION DEVICE, the disclosure of which is incorporated herein.

The light source can be a laser or LED and can include one or more lenses for modifying the illumination beam angular characteristics. The image source can be a micro-display or laser based display. LED will provide better uniformity than laser. If laser illumination is used there is a risk of illumination banding occurring at the waveguide output. In some embodiments laser illumination banding in waveguides can be overcome using the techniques and teachings disclosed in U.S. Provisional Patent Application No. 62/071,277 entitled METHOD AND OPTICAL DISPLAY FOR GENERATING INPUT IMAGES FOR HOLOGRAPHIC WAVEGFUIDE DISPLAYS, the disclosure of which is incorporated herein. In some embodiments, the light from the light source 101 is polarized. In one or more embodiments, the image source is a liquid crystal display (LCD) micro display or liquid crystal on silicon (LCoS) micro display.

The light path from the source to the waveguide via the IIN is indicated by rays1000-1003. The input grating of each grating layer couples a portion of the light into a TIR path in the waveguide once such path being represented by the rays 1004-1005. The output waveguides 107A, 107C diffract light out of the waveguide into angular ranges of collimated light 1006,1007 respectively for viewing by the eye 108. The angular ranges, which correspond to the field of view of the display, are defined solely by the IIN optics. In some embodiments, the waveguide gratings may encoded optical power for adjusting the collimation of the output. In some embodiments, the output image is at infinity. In some embodiments, the output image may be formed at distances of several meters from the eye box. Typically, the eye is positioned within the exit pupil or eye box of the display.

In some embodiments, similar to the one shown in FIG. 1 each grating layer addresses half the total field of view. Typically, the fold gratings are clocked (that is, tilted in the waveguide plane) at 45° to ensure adequate angular bandwidth for the folded light. However, some embodiments of the invention may use other clock angles to satisfy spatial constraints on the positioning of the gratings that may arise in the ergonomic design of the display. In some embodiments, at least one of the input and output gratings have rolled k-vectors. The K-vector is a vector aligned normal to the grating planes (or fringes) which determines the optical efficiency for a given range of input and diffracted angles. Rolling the K-vectors allows the angular bandwidth of the grating to be expanded without the need to increase the waveguide thickness.

In some embodiments, the fold grating angular bandwidth can be enhanced by designing the grating prescription provides dual interaction of the guided light with the grating. Exemplary embodiments of dual interaction fold gratings are disclosed in U.S. patent application Ser. No. 14/620,969 entitled WAVEGUIDE GRATING DEVICE, the disclosure of which is incorporated herein.

In some embodiments, at least one of the input, fold or output gratings may combine two or more angular diffraction prescriptions to expand the angular bandwidth. Similarly, in some embodiments at least one of the input, fold or output gratings may combine two or more spectral diffraction prescriptions to expand the spectral bandwidth. For example, a color multiplexed grating may be used to diffract two or more of the primary colors.

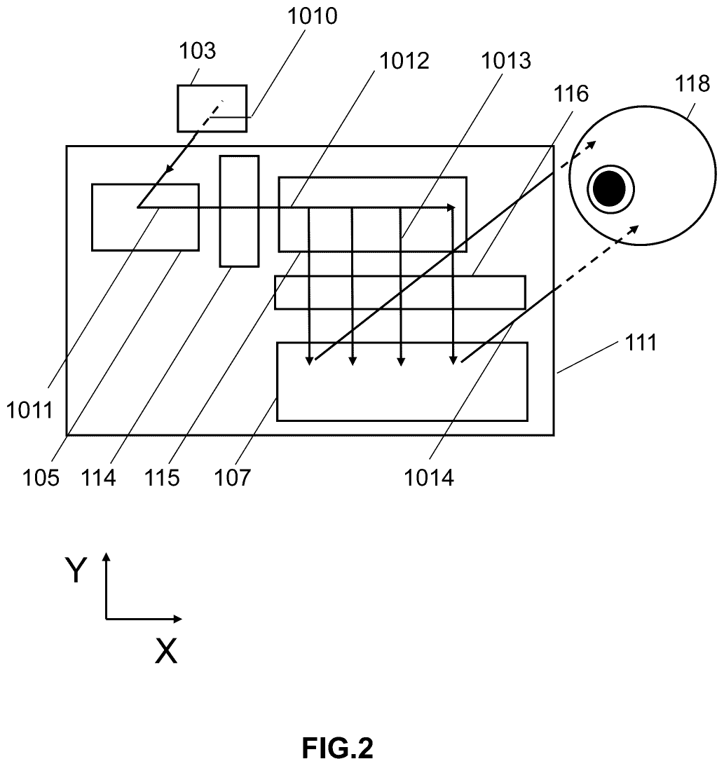

FIG. 2 is a plan view of a single grating layer similar to the ones used in FIG. 1. The grating layer 111, which is optically coupled to the IIN 103, comprises input grating 105, a first beamsplitter 114, a fold grating 115, a second beamsplitter 116 and an output grating 107. The beamsplitter are partially transmitting coatings which homogenize the wave guided light by providing multiple reflection paths within the waveguide. Each beamsplitter may comprise more than one coating layer with each coating layer being applied to a transparent substrate. Typical beam paths from the IIN up to the eye 118 are indicated by the rays 1010-1014.

By using the fold grating, the waveguide display may use fewer layers than previous systems and methods of displaying information according to some embodiments. In addition, by using fold grating, light can travel by total internal refection within the waveguide in a single rectangular prism defined by the waveguide outer surfaces while achieving dual pupil expansion. In another embodiment, the input grating, the fold grating and the output grating can be created by interfering two waves of light at an angle within the substrate to create a holographic wave front, thereby creating light and dark fringes that are set in the waveguide substrate at a desired angle

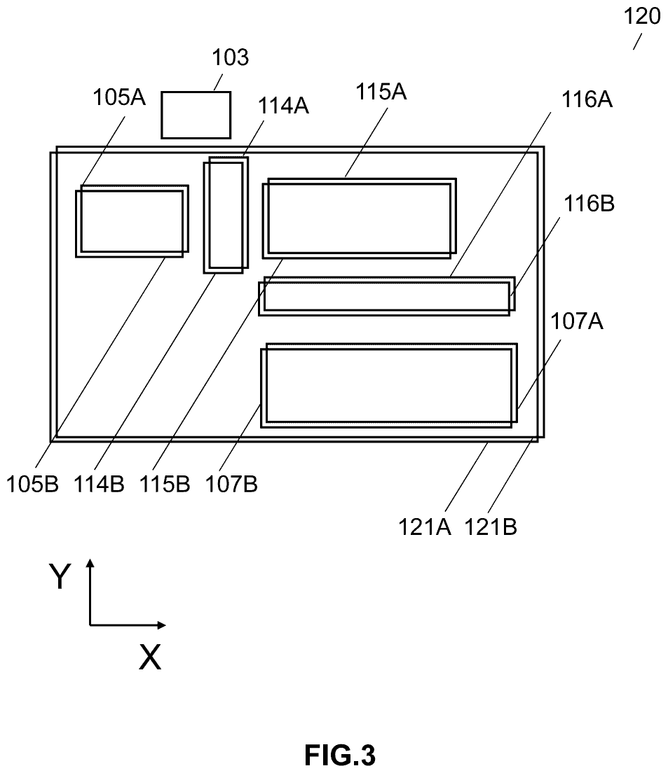

FIG. 3 illustrates a plan view of a two grating layer configuration similar to the ones used in FIG. 1. The grating layers 121A, 121B which are optically coupled to the IIN 103 comprise input gratings 105A, 105B, first beamsplitters 114A, 114B, fold gratings 115A, 115B, second beamsplitters 116A,116B and output gratings 107A, 107B, where the characters A, B refer to the first and second grating layers and the gratings and beams splitters of the two layers substantially overlap.

In many waveguide configurations, the input, fold, and output gratings are formed in a single layer sandwiched by transparent substrates. FIG. 1 illustrates such stacking in reference to items 104A and 104B. In some embodiments, the waveguide may comprise just one grating layer. In some embodiments, the cell substrates may be fabricated from glass. An exemplary glass substrate is standard Corning Willow glass substrate (index 1.51) which is available in thicknesses down to 50 micron. In other embodiments the cell substrates may be optical plastics.

In some embodiments, the grating layer may be broken up into separate layers. For example, in some embodiments, a first layer includes the fold grating while a second layer includes the output grating. In some embodiments, a third layer can include the input grating. The number of layers may then be laminated together into a single waveguide substrate. In some embodiments, the grating layer is comprised of a number of pieces including the input coupler, the fold grating and the output grating (or portions thereof) that are laminated together to form a single substrate waveguide. The pieces may be separated by optical glue or other transparent material of refractive index matching that of the pieces.

Some embodiments may comprise a grating layer be formed via a cell making process by creating cells of the desired grating thickness and vacuum filling each cell with SBG material for each of the input coupler, the fold grating and the output grating. In one embodiment, the cell is formed by positioning multiple plates of glass with gaps between the plates of glass that define the desired grating thickness for the input coupler, the fold grating and the output grating. In one embodiment, one cell may be made with multiple apertures such that the separate apertures are filled with different pockets of SBG material. Any intervening spaces may then be separated by a separating material (e.g., glue, oil, etc.) to define separate areas.

In other embodiments, the SBG material may be spin-coated onto a substrate and then covered by a second substrate after curing of the material. In some embodiments, the grating in a given layer is recorded in stepwise fashion by scanning or stepping the recording laser beams across the grating area. In many embodiments the gratings may be recorded using mastering and contact copying process currently used in the holographic printing industry.

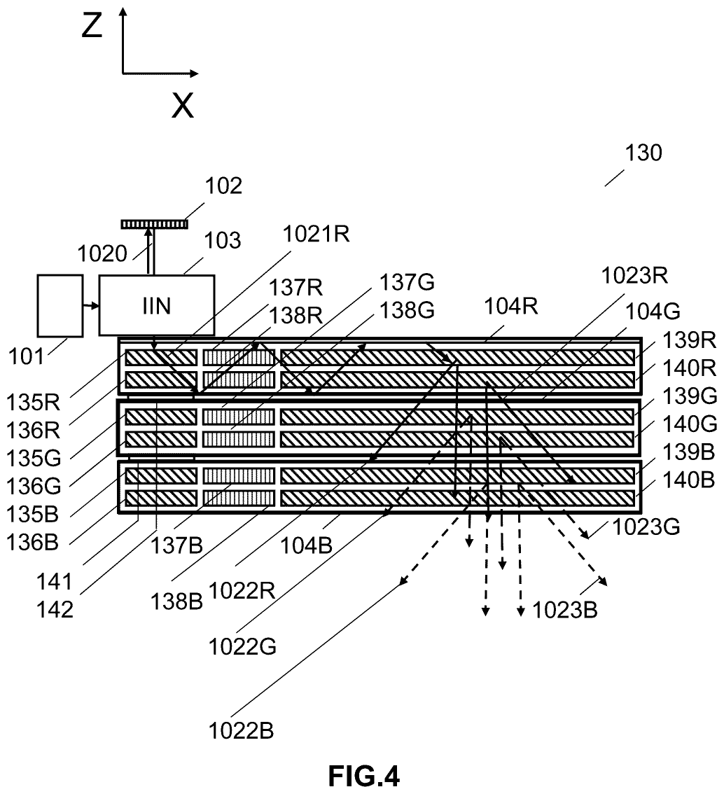

The embodiment illustrated in FIG. 1 represents a monochrome waveguide display. As an improvement one may utilize a stack of monochrome waveguides to derive a color display as illustrated in FIG. 4. FIG. 4 illustrates a dual axis expansion waveguide display 130 comprising a light source 101 a microdisplay panel 102 and an input image node (IIN) 103 optically coupled to red, green and blue waveguides 104R, 104G, 104B, which each comprise two grating layers. In order that wave guiding can take place in each waveguide the three waveguides are separated by air gaps. In some embodiments, the waveguides are separated by a low index material such as a nanoporous film. The red grating layer labelled by R contains an input grating 135R, 136R, a fold grating exit pupil expander 137R, 138R and an output grating 139R, 140R. The grating elements of the blue and green waveguides are labeled using the same numerals with B and G designating blue and green. Since the light paths through the IIN and waveguides in each of the red green and blue waveguides are similar to those illustrated in FIG. 1 they are nots shown in FIG. 4. In some embodiments, the input, fold and output gratings are all passive, that is non-switching. In some embodiments, at least one of the gratings is switching. In some embodiments, the input gratings in each layer are switchable to avoid color crosstalk between the waveguide layers. In some embodiments color crosstalk is avoided by disposing dichroic filters 141,142 between the input grating regions of the red and blue and the blue and green waveguides.

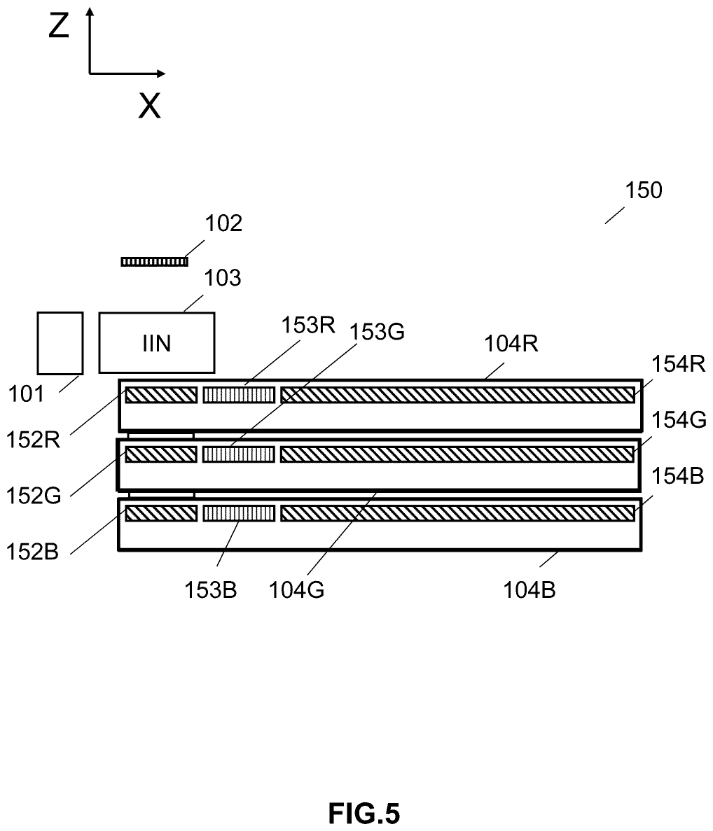

In some embodiments, a color waveguide may use just one grating layer in each monochromatic waveguide, as illustrated in FIG. 5. The embodiment illustrated in FIG. 5 represents a similar configuration as that shown in FIG. 4 with each of the red, green, and blue waveguides (104R, 104G, and 104B) comprising only a single grating layer. Each grating layer having an input grating (152R, 152G, and 152B), a fold grating (153R, 153G, 153B), and an output grating (154R, 154G, 154B) for each of the respective red, green, and blue layers.

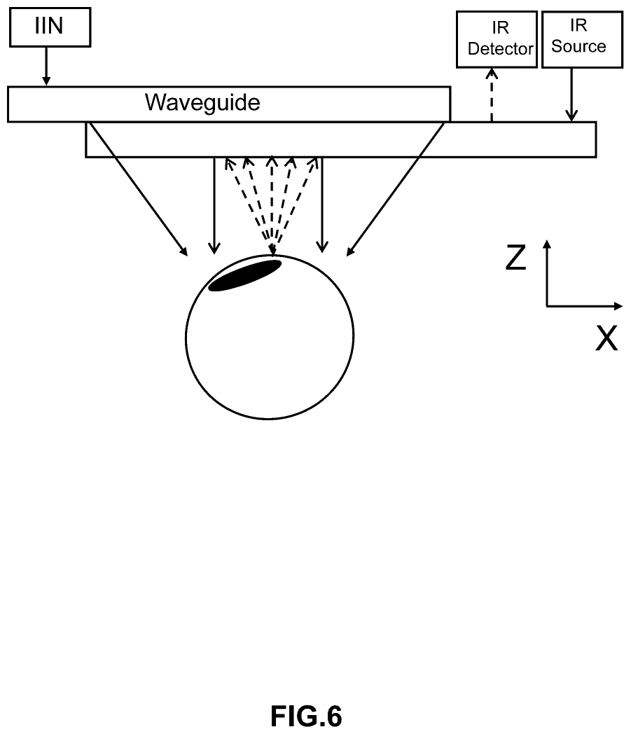

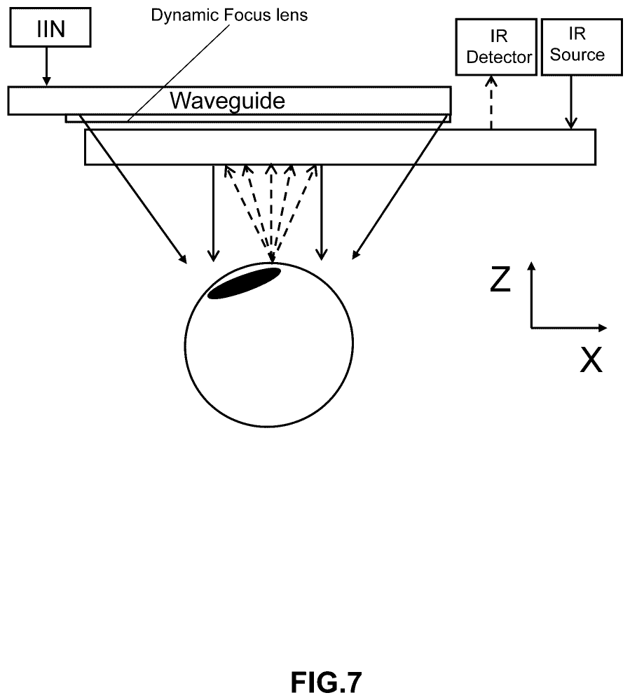

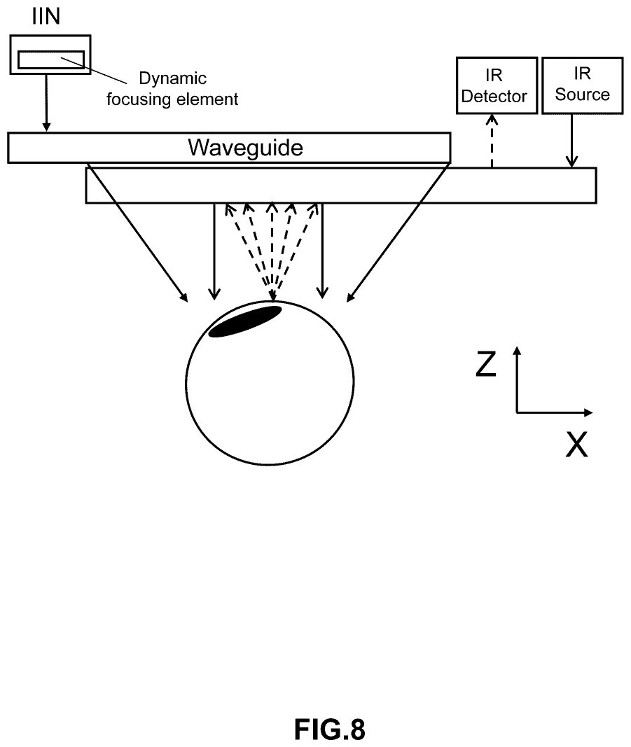

Some embodiments of the waveguide may include an eye tracker. One such embodiment is illustrated in FIGS. 6, 7, and 8. The teachings of the various embodiments of the eye tracker configuration may be further illustrated in PCT/GB2014/000197 entitled HOLOGRAPHIC WAVEGUIDE EYE TRACKER, PCT/GB2015/000274 entitled HOLOGRAPHIC WAVEGUIDE OPTICALTRACKER, PCT Application No.: GB2013/000210 entitled OPTICAL DISPLAY FOR EYE TRACKING, U.S. Provisional Patent Application No. 62/176,572 entitled ELECTRICALLY FOCUS TUNABLE LENS, and U.S. Provisional Patent Application No. 62/125,089 entitled HOLOGRAPHIC WAVEGUIDE LIGHT FIELD DISPLAYS, the disclosures of each of which are incorporated herein by reference. Some embodiments may additionally comprise a dynamic focus lens as illustrated in FIG. 7 the effect of which is to provide a multiplicity of image surfaces.

In various embodiments of the invention the IIN is optically matched to the waveguide. Waveguides raise optical interfacing issues that are not encountered in conventional optical systems in particular matching the input image angular content to the angular capacity of the waveguide and input grating. The optical design challenge is to match the IIN aperture variation as a function of field angle to the rolled K-vector input grating diffraction direction. In various embodiments the waveguide is designed to make the waveguide thickness as small as possible while maximizing the spread of field angles at any given point on the input grating, subject to the limits imposed by the angular bandwidth of the input grating, and the angular carrying capacity of the waveguide.

It should be appreciated that coupling collimated angular image content over the full field of view and without significant non-uniformity of the illumination distribution across the pupil requires a Numerical Aperture (NA) variation ranging from high NA on one side of the microdisplay falling smoothly to a low NA at the other side. NA is defined as being proportional to the sine of the maximum angle of the image ray cone from a point on the microdisplay surface with respect to an axis normal to the microdisplay. Other equivalent measures may be used for the purposes of determining the most optimal IIN to waveguide coupling. Controlling the NA in this way will ensure high optical efficiency and reduced banding and other illumination non-homogeneities in the case of LED-illuminated displays. Laser-illuminated displays will also benefit from the control of NA variation across the microdisplay particular with regard to homogeneity.

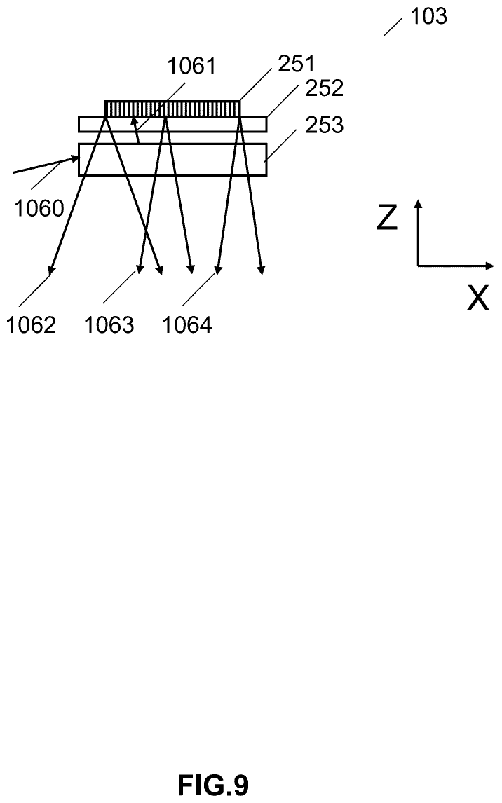

In many embodiments, as illustrated, in FIG. 9 the IIN 103 comprises a microdisplay panel 251 a spatially-varying NA component 252 and microdisplay optics 253. The microdisplay optics accepts light 1060 from an illumination source which is not illustrated and deflects the light on to the microdisplay in the direction indicated by the ray 1061. The light reflected from the microdisplay is indicated by the divergent ray pairs 1062-1064 with NA angles varying along the X axis.

Although a particular configuration of the IIN 103 is illustrated in FIG. 9, it should be understood that a variety of configurations may be used to ensure the most efficient image quality is produced. By way of example the spatially-varying NA component may be located adjacent to the output surface. Additionally, the microdisplay may function as a reflective device, as illustrated in FIG. 9, or may function as a transmission or emissive device.

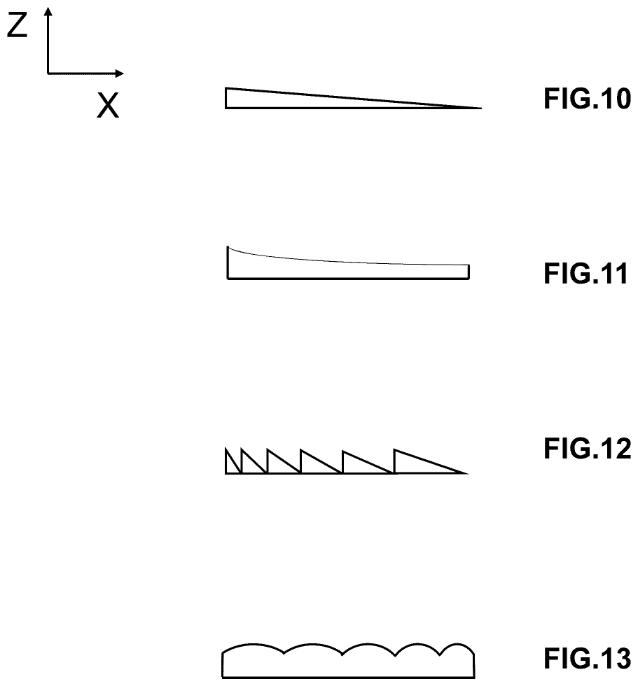

Furthermore, the spatially-varying NA component may take on a variety of configurations having a uniformly varying NA characteristic. Various exemplary embodiments are illustrated in FIGS. 10-13. Some embodiments may include a wedge as illustrated in FIG. 10 while others may be variations of such. FIG. 11 illustrates a spatially-varying NA component in a curved wedge format. FIG. 12 illustrates an exemplary embodiment wherein the NA component comprises an array of a plurality of prismatic elements having differing prism angles. Additionally, some NA components may comprise an array of lenses with various apertures and optical powers, as illustrated in FIG. 13.

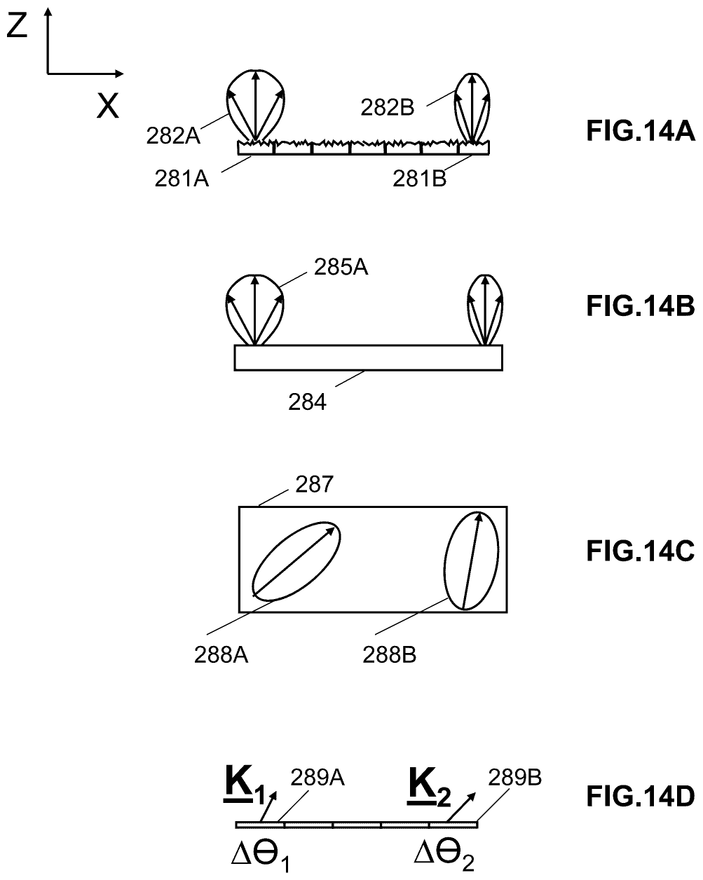

In addition to the various profile characteristics illustrated in FIGS. 10-13, spatially-varying NA components may comprise a variety of surface features or internal substrate configurations designed with a variety of scatter elements. FIG. 14A illustrates a spatially-varying NA component having a scatter element integrated with the surface texture. FIG. 14B illustrates a substrate of the spatially-varying NA component having scattering properties as part of the base substrate. Such properties may come from a variety of configurations that may include individual scatter components suspended within the body of the substrate.

In some embodiments, such as the one illustrated in FIG. 14C a spatially-varying NA component 286 comprises a birefringent substrate 287 having a spatially varying birefringence as represented by the uniaxial crystal index functions 288A, 288B. In some embodiments, the substrate provides a continuous variation of birefringence. In some embodiments, the substrates comprise discrete elements each have a unique birefringence. In some embodiments, a spatially-varying NA component is a scattering substrate with birefringent properties. In some embodiments, a spatially-varying NA component is based on any of the embodiments of FIGS. 10-13 implements using a birefringent substrate. In some embodiments, the NA variation across the field is performed using a birefringent layer having comprising a thin substrate coated with a Reactive Mesogen material. Reactive Mesogens are polymerizable liquid crystals comprising liquid crystalline monomers containing, for example, reactive acrylate end groups, which polymerize with one another in the presence of photo-initiators and directional UV light to form a rigid network. The mutual polymerization of the ends of the liquid crystal molecules freezes their orientation into a three-dimensional pattern. Exemplary Reactive Mesogen materials are manufactured by Merck KgaA (Germany).

In some embodiments, such as the one illustrated in FIG. 14D a spatially-varying NA component 286 comprises an array of diffractive elements each characterized by a unique K-vector and diffraction efficiency angular bandwidth. For example element 289A at one end of the component has k-vector K₁ and bandwidth Δθ₁ configured to provide a high NA while element 289B at the other end has k-vector K₂ and bandwidth Δθ₂ configured to provide a low NA. In some embodiments, the grating characteristics vary continuously across the substrate. In some embodiments, the gratings are Bragg holograms recorded in HPDLC materials. In some embodiments, the gratings are surface relief gratings. In some embodiments, the gratings are computer generated diffractive structures such as computer generated holograms (CGHs).

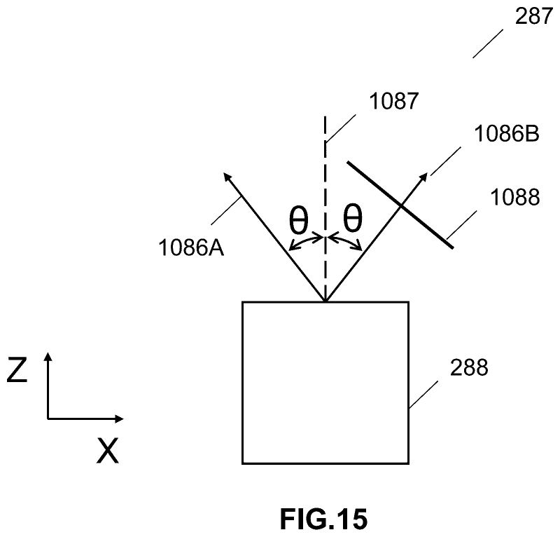

In some embodiments, the IIN design addresses the NA variation problem, at least in part, by tilting the stop plane such that its normal vector is aligned parallel to the highest horizontal field angle, (rather than parallel to the optical axis). As illustrated in FIG. 15 the IIN 287 is configured to provide an output field of view of half angle θ defined by the limiting rays 1086A, 1086B disposed symmetrical about the optical axis 1087. The stop plane 1088 is normal to the limiting ray 1086B. It is assumed that the waveguide input grating, which is not illustrated, couples the horizontal field of view into the waveguide (not shown).

Although the present application does not assume any particular configuration of the microdisplay optics 253, further embodiments may be further represented in U.S. patent application Ser. No. 13/869,866 entitled HOLOGRAPHIC WIDE ANGLE DISPLAY, and U.S. patent application Ser. No. 13/844,456 entitled TRANSPARENT WAVEGUIDE DISPLAY, the disclosures of which are incorporated herein. In some embodiments, the microdisplay optics contains at least one of a refractive component and curved reflecting surfaces or a diffractive optical element for controlling the numerical aperture of the illumination light. In some embodiments, the microdisplay optics contains spectral filters for controlling the wavelength characteristics of the illumination light. In some embodiments, the microdisplay optics contains apertures, masks, filter, and coatings for controlling stray light. In some embodiments, the microdisplay optics incorporate birdbath optics.

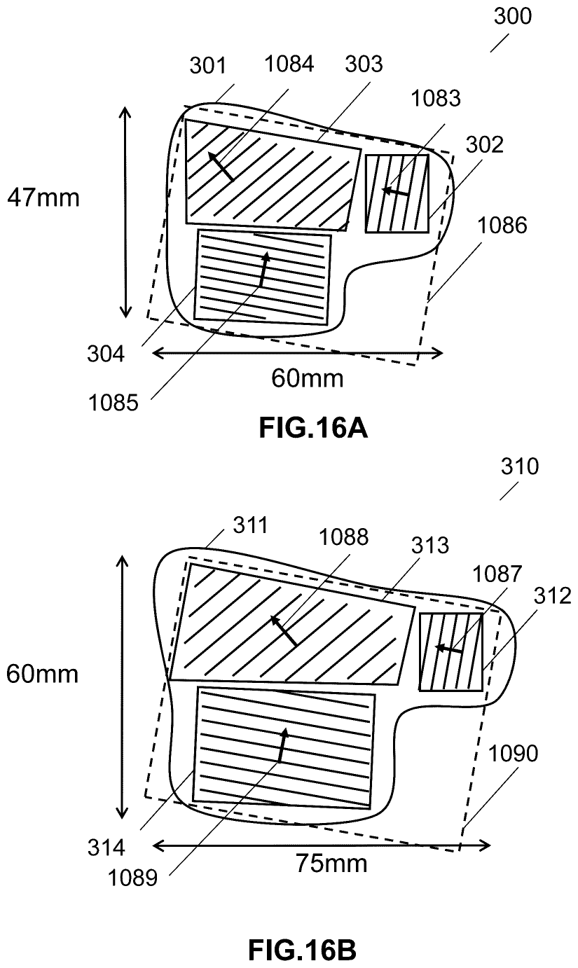

FIG. 16 shows schematic front views of two waveguide grating layouts that may be provided by the invention. In the embodiment of FIG. 16A the waveguide 300 comprises a shaped waveguide comprising in a single layer indicted by 1086 an input grating 302, a fold grating 303 and an output grating 304. The K-vectors of the three gratings (that is the normal vector to the fringes shown inside each grating) are indicated by 1083-1084. Note that in each case the K-vector is projected in the plane of the drawings. In the embodiment of FIG. 16B the waveguide 310 comprises a shaped waveguide comprising in a single layer indicted by 1090 an input grating 313, a fold grating 314 and an output grating 315. The K-vectors of the three gratings (that is the normal vector to the fringes shown inside each grating) are indicated by 1087-1089. In each case the K-vector is projected in the plane of the drawings.

FIG. 17 shows a further general waveguide grating layout that may be provided by the invention. The waveguide 320 comprises a rectangular waveguide comprising in a single layer an input grating 322, a fold grating 323 and an output grating 324. The K-vectors of the three gratings (that is the normal vector to the fringes shown inside each grating) are indicated by 1091-1093. In each case the K-vector is projected in the plane of the drawings. The fold grating in this case has Bragg fringes aligned at 45 degrees in the plane of the grating

### Embodiments of Wearable HUDs

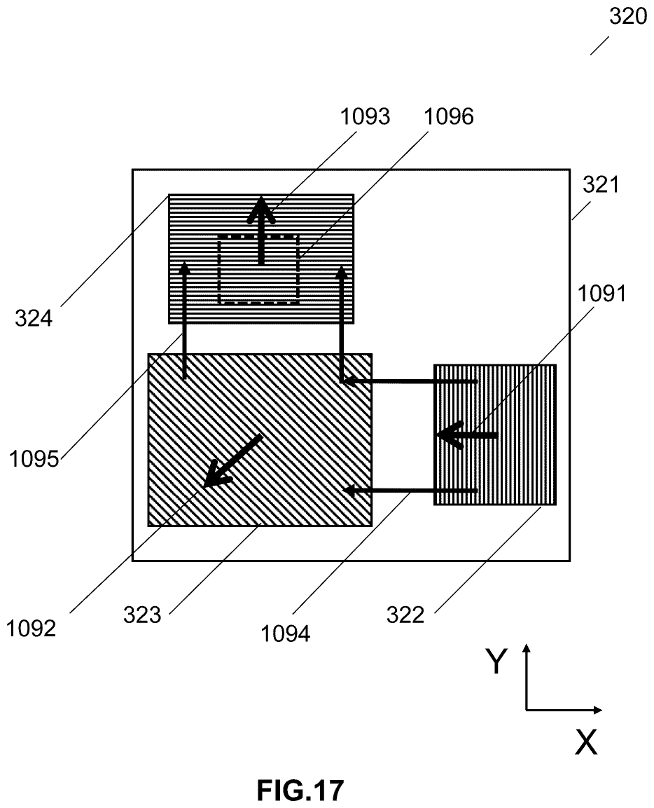

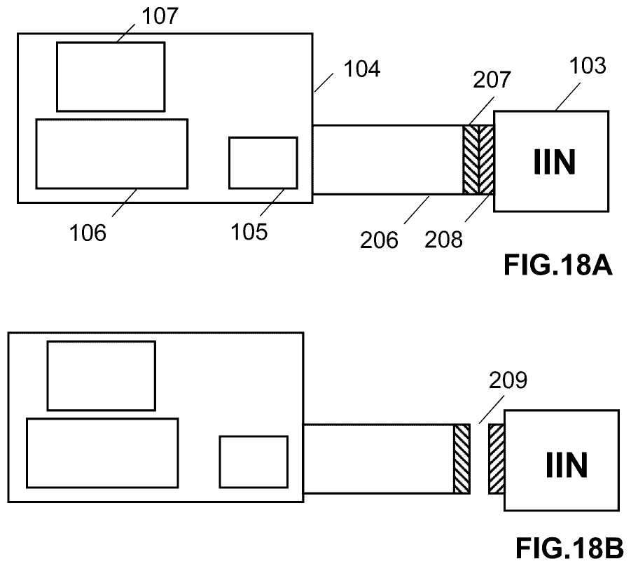

Turning now to FIGS. 18A and 18B. In many embodiments, the waveguide display is coupled to the IIN 103 by an opto-mechanical interface thereby allowing the waveguide to be easily retracted from the IIN assembly. The basic principle is illustrated in FIG. 18A which shows a dual axis expansion waveguide display 200 comprising the waveguide 201 containing the input grating 105, fold grating 106 and output grating 107 and the IIN 103. The optical display further comprises an optical link 206 connected to the waveguide, a first optical interface 207 terminating the optical link and a second optical interface 208 forming the exit optical port of the IIN. The first and second optical interfaces can be decoupled as indicated by the gap 209 illustrated in FIG. 18B. In some embodiments the optical link may be a waveguide itself optically designed to work with the main waveguide display 104. In some embodiments, the optical link is curved. In some embodiments, the optical link is a GRIN image relay device. In many embodiments, the optical connection is established using a mechanical mechanism. In some embodiments, the optical connection is established using a magnetic mechanism. The advantage of decoupling the waveguide from the IIN in helmet mounted display applications is that the near eye portion of the display be removed when not in used. In some embodiments where the waveguide comprises passive gratings the near eye optics can be disposable

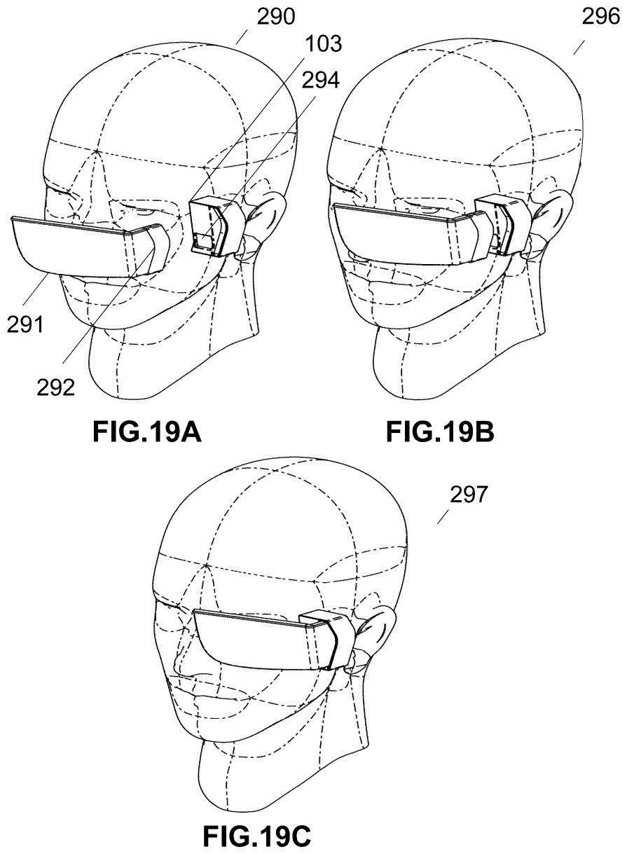

As discussed above, in some embodiments such as the one illustrated in FIGS. 18A-19C the waveguide display is coupled to the IIN by an opto-mechanical interface that allows the waveguide to be easily retracted from the IIN assembly. FIG. 19A shows a removable near eye display 290 comprising a near eye waveguide component 291 and an IIN 103. The waveguide component includes an opto-mechanical interface 292 configured to optically match the IIN and removably connect to the opto-mechanical interface of the IIN 294. The waveguide component 291 can have at least two configurations with respect to the IIN. As illustrated by FIG. 19A the waveguide component 291 is in a removed or retracted configuration. The waveguide is shown retracted from the IIN assembly. FIG. 19B shows a second 3D view of the HMD 296 with the waveguide component retracted. FIG. 19C illustrates a connected position of the waveguide component 291 wherein the component is opto-mechanically connected to the IIN 103.

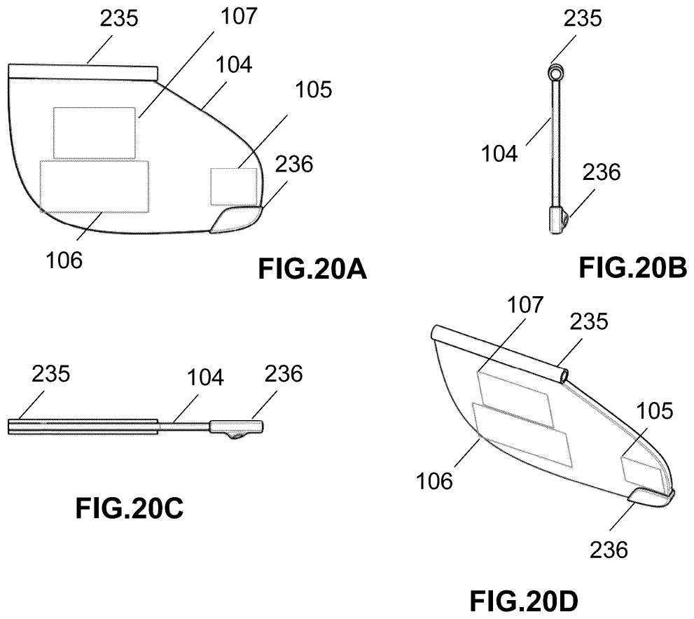

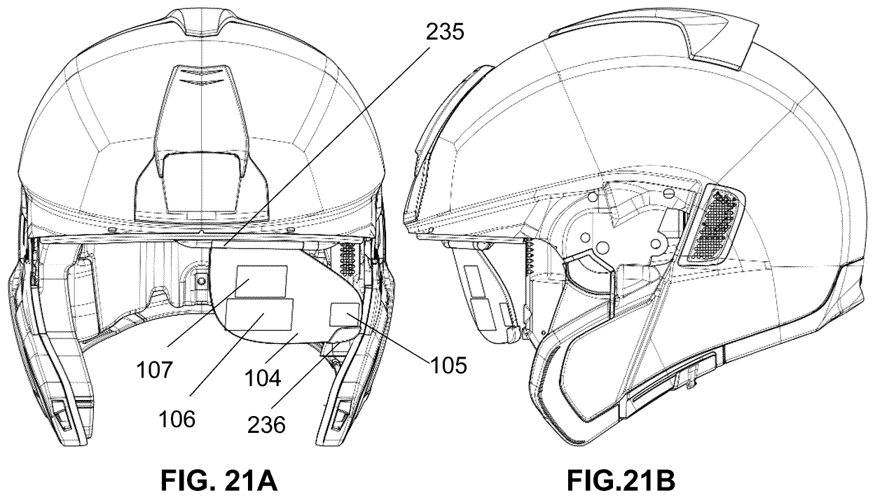

FIG. 20A-21B illustrate an exemplary embodiment of a waveguide display that may be integrated into a helmet. FIGS. 20A-20D illustrate front, plan, side, and three-dimensional views of one eyepiece of a dual axis expansion display that may be used in a helmet mount display. One such embodiment may be in a motorcycle helmet. The display comprises the waveguide 104, input grating 105, fold grating 106, output grating 107; which were previously described in more detail. Additionally, the waveguide display of FIGS. 20A-20D may include a hinge mechanism 235 for attaching the display to the helmet and the waveguide coupling mechanism 236 configured to opto-mechanically couple to the IIN assembly.

FIG. 21A and FIG. 21B show a frontal view and a side view of a HUD eyepiece integrated in a helmet. Although a particular helmet configuration is shown it should be understood that any acceptable configuration may be implemented.

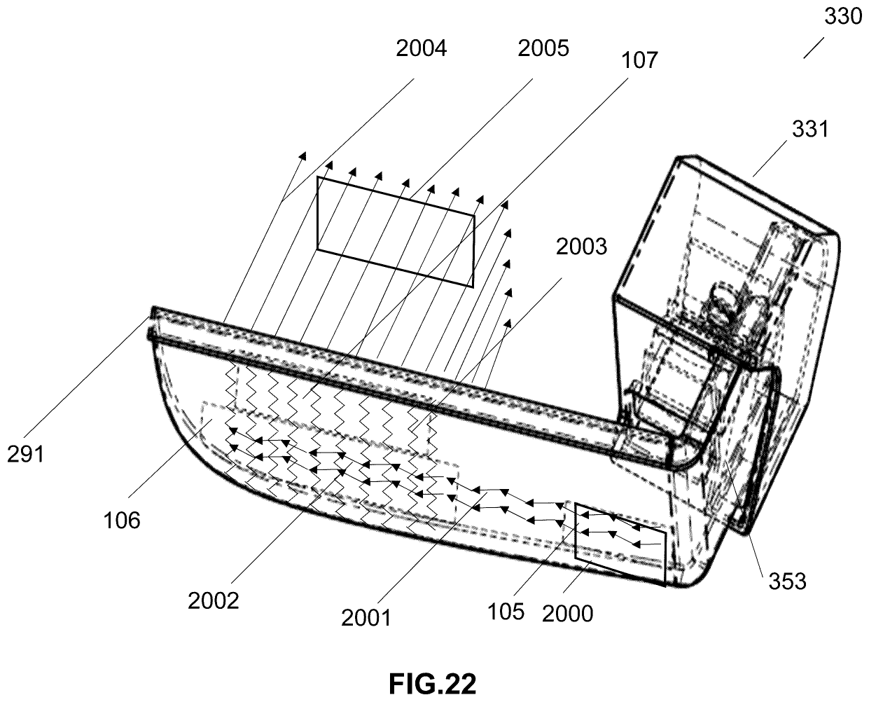

Turning now to FIG. 22, an exemplary embodiment of a HUD 330 waveguide display is thus illustrated. FIG. 22 illustrates a waveguide display in the form of a near eye display. The near eye display comprises an IIN assembly 331 and a waveguide component 291 opto-mechanically coupled to the IIN assembly 331. The waveguide component further comprises an input grating 105 a fold grating 106 and an output grating 107. Although not shown here the waveguide component is further configured with an opto-mechanical interface 353 for coupling the waveguide to the INN assembly 331. The waveguide path from entrance pupil 2000 through the input grating, fold grating and output grating and up to the eye box 2005 is represented by the rays 2001-2004.

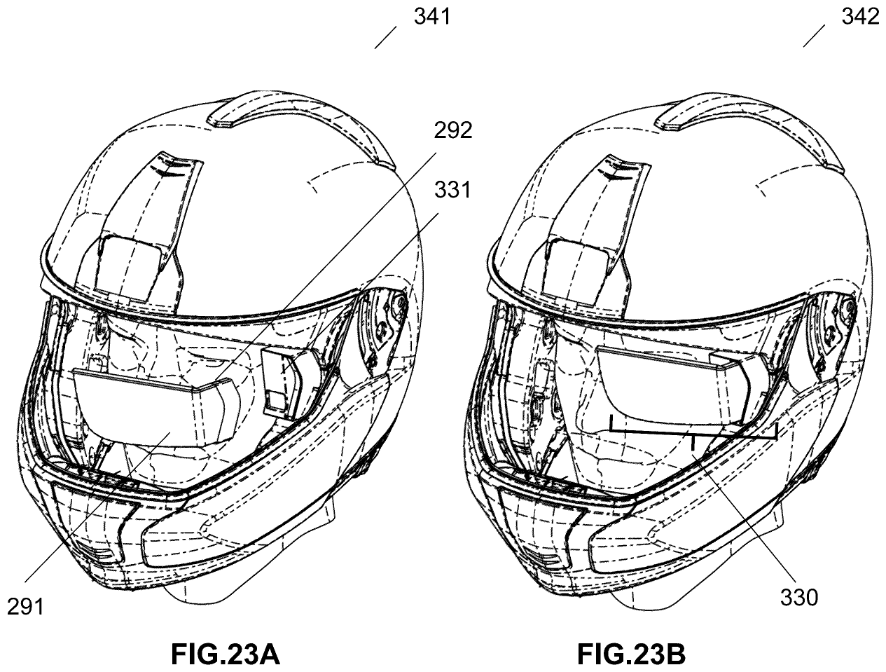

FIGS. 23A and 23B provide illustrations of various operational positions according to the invention whereby the HUD 330, as illustrated in FIGS. 22 and 19A-19C, is provided as a HMD integrated in a helmet. In such an embodiment the IIN assembly 331 may form part of the helmet or may be added aftermarket. Similar to FIGS. 19A and 19B, FIG. 23A illustrates a HUD display 330 in a first operational state 341 in which the waveguide component 291 is fully retracted from the IIN assembly 331. Similarly, FIG. 23B illustrates the display in a second operational state 342 with the waveguide component 291 coupled to the IIN assembly.

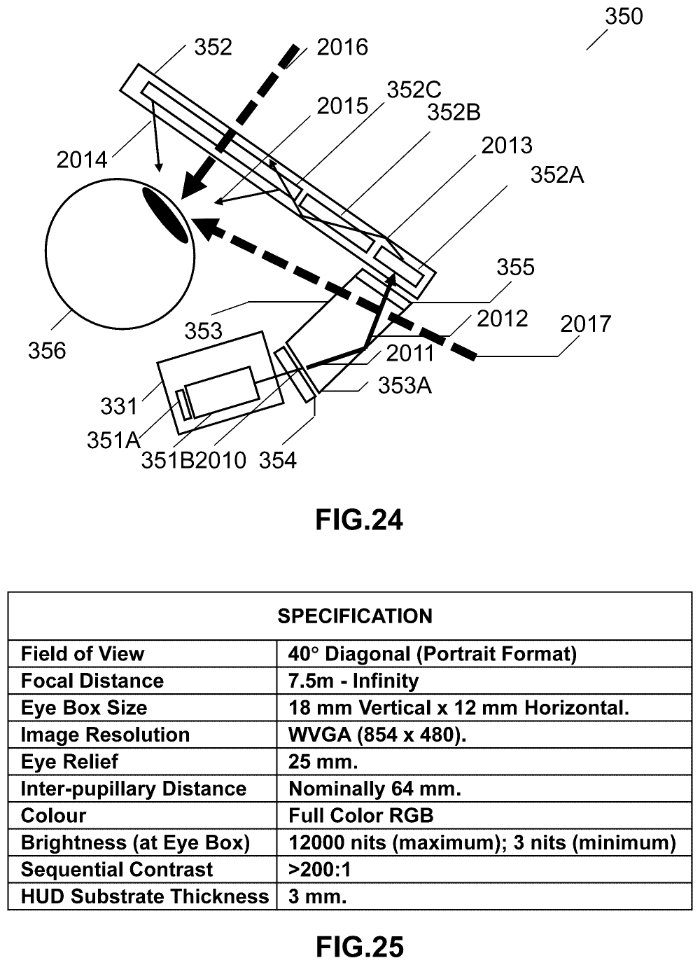

In many embodiments, such as the one illustrated in FIG. 24, a display according to the principles of the invention comprises an IIN assembly 331 a waveguide eyepiece 352 (which is part of the overall waveguide component previously described) and prismatic relay optics 353. The IIN contains at least the microdisplay panel 351A illuminated by a light source which is not shown and projection optics 2010 which typically comprises refractive optics. The IIN assembly 331 is coupled to the prismatic relay optics by a coupler assembly 354 which provides mechanical support and an optical connection to admit light from the IIN assembly 331 into the prismatic relay optics 353. The prismatic relay optics comprises a reflective surface 353A which may be a TIR surface or may alternatively support a reflective coating. Light from the prismatic relay optics 353 is coupled into the waveguide eyepiece 352 via the optical interface layer 355 which in some embodiments provides polarization selectivity. In some embodiments, the optical interface layer 355 provides one of spectral or angular selectivity. In some embodiments, the optical interface layer 355 is a diffractive optical element. In some embodiments, at least one of the transmitting or reflecting surfaces of the prismatic relay optics has optical power. In some embodiments, at least one of the transmitting or reflecting surfaces of the prismatic relay optics supports at least one coating for controlling at least one of polarization, reflection or transmission as a function of wavelength or angle. The image light from the IIN is expanded in the prism to produce sufficient beam width aperture to enable a high efficiency “Roll-K Vector” input aperture-thus preserving efficiency and brightness.

In some embodiments, the waveguide eyepiece 352 comprises input, fold and output gratings disposed in separate red, green and blue diffracting layers or multiplexed into fewer layers as discussed above. For simplicity, the gratings in FIG. 24 are represented by the input grating 352A, fold grating 352B and output grating 352C. The light path from the projector through the prismatic relay optics and the waveguide is represented by the rays 2010-2013. The output image light viewed by the eye 356 is represented by the rays 2014 and 2015. The rays 2016 and 2017 illustrate the transparent of the waveguide to external light forward of the eyepiece and the transparency of the prismatic relay optics to external light in the periphery of the display wearer's field of view.

In some embodiments, based on the above described display architectures, may also implement a photodetector for detection of ambient light levels for the purpose of matching the display image luminance to the external scene luminance. Although, not shown in in the figures, such photodetectors may be integrated into the helmet structure or electromechanically connected to the HUD display.

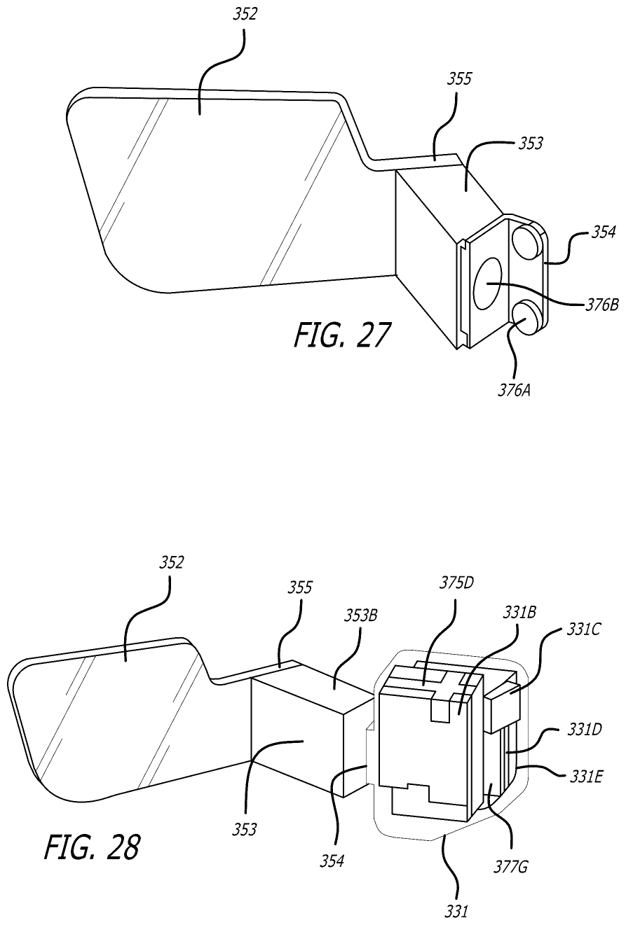

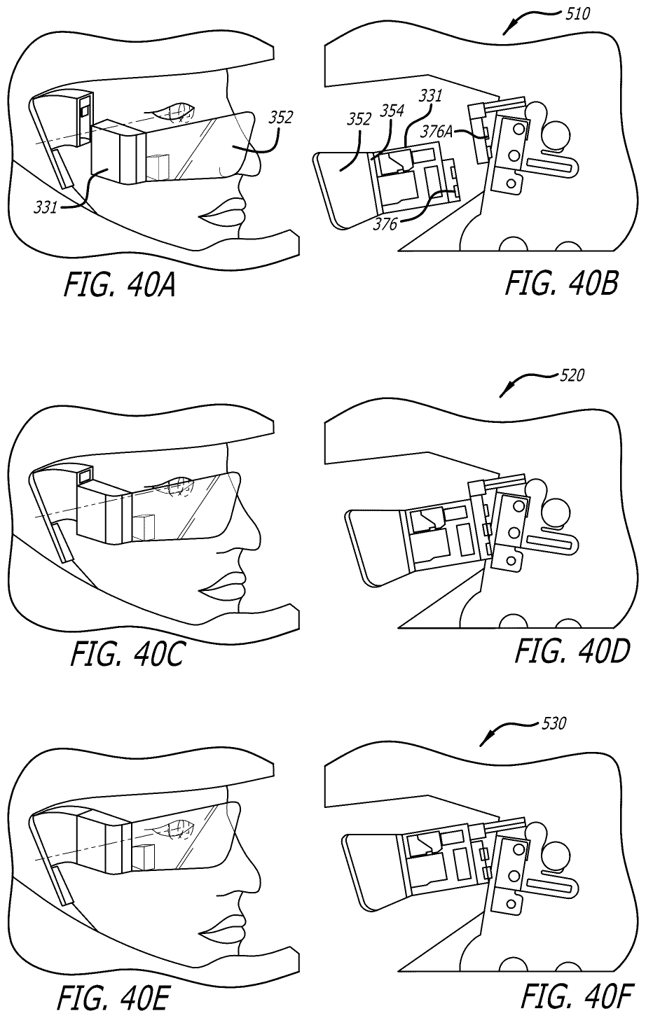

Additionally, although it is largely represented in the figures in one configuration it should be noted that the prismatic relay optics may take on any suitable configuration. As illustrated in FIGS. 24 and 27, the prismatic relay optics comprise an elongated prism form whereas for example FIGS. 40A-40F illustrate a prismatic relay optics as being largely flat. In some embodiments the prismatic relay optics may be integrated within or right next to the IIN assembly.

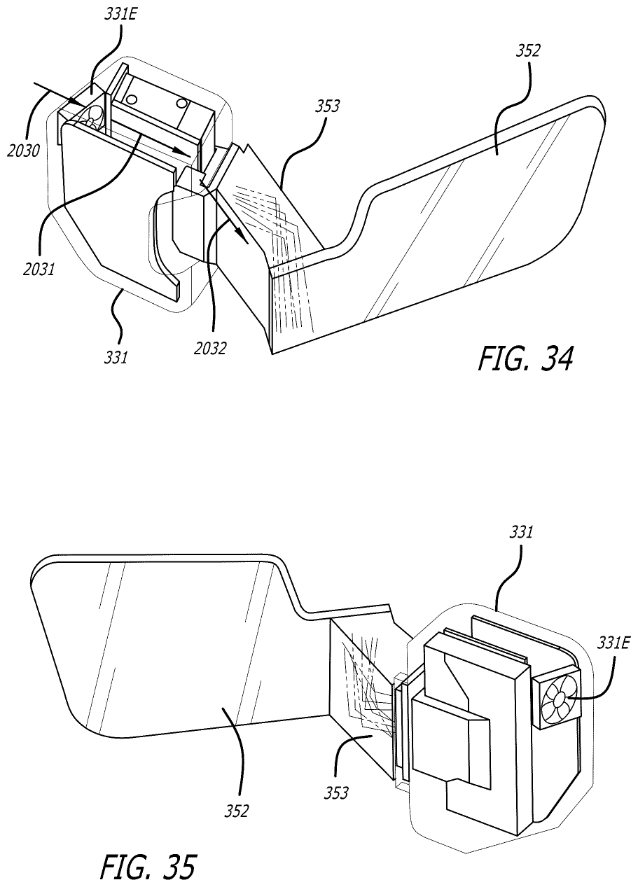

One exemplary embodiment of the invention for use in a helmet HUD is illustrated FIGS. 27-39 which illustrate details of the waveguide eyepiece, IIN, and associated prismatic relay optics linking the IIN and waveguide eyepiece. Design specifications in accordance with many embodiments of the invention are illustrated by the table in FIG. 25. Such specifications include the Eye box size, focal distance and image resolution, and are presented for exemplary purposes only.

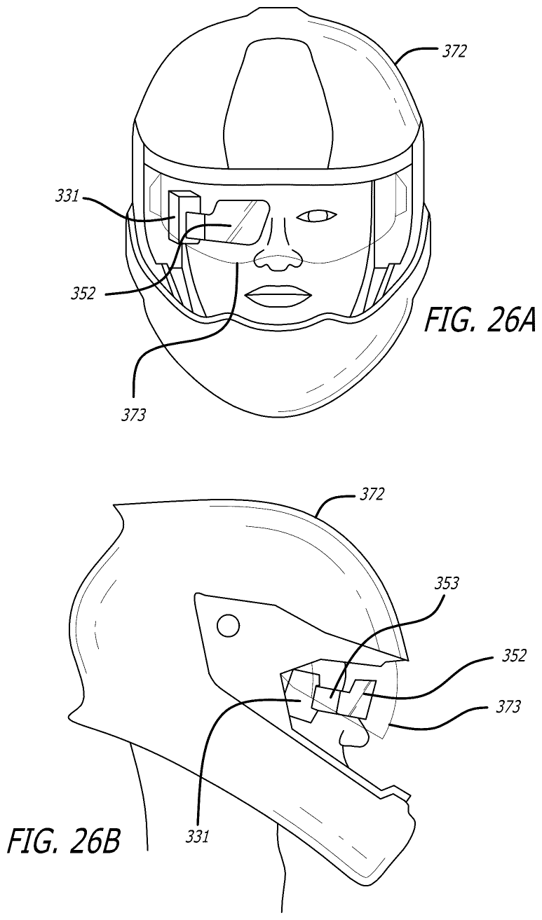

FIG. 26A and FIG. 26B provide a schematic front and side elevation views a helmet HUD. As described in other figures, the display comprises a waveguide eye piece 352, prismatic relay couple 353 and the IIN assembly 331. Additionally, FIG. 26A and 26B illustrate one embodiment of the HUD integrated with a helmet where the HUD's spatial relation with respect to the Helmet visor 373 is shown. In accordance with many embodiments of the invention, where the HUD is integrated with a helmet as illustrated in FIGS. 26A and 26B, the waveguide eyepiece 352 may be tilted (rake angle) to the horizontal plane to avoid the visor. In various embodiments the rake angle may be at least 20 degrees, in accordance with many embodiments, the rake angle is at least 25 degrees, which enables eye-relief at least 25 mm while providing generous visor clearance. In many embodiments the design allows the eyepieces to translate between the left and right sides of helmet.

In accordance with other embodiments FIG. 27 illustrates a detail of the headpiece HUD comprising the waveguide eyepiece 352, the prismatic relay optics 353, and a frame or coupler 354, which may serve as the opto-mechanical coupling between the waveguide component and the IIN. In accordance with some embodiments the frame or coupler 354 may comprise a mechanical attachment point that may be selected from a group consisting of a magnet, hinge, or USB connection. In many embodiments the prismatic relay optics are visually transparent to allow ambient light and ensure increased field of vision of the user. In accordance with many embodiments the prism assembly also comprises a corner coupler molding and beam splitter window 355 and a prism window 353B.

In accordance with many embodiments of the invention the opto-mechanical coupler 354 that couples the prismatic relay optics 353 to the IIN 331 as illustrated in FIGS. 26-30 represents a component of the HUD display. The coupler 354 may comprise a plurality of alignment characteristics such as magnets, pins, or other physical characteristics to ensure the proper optical alignment of the IIN, the prismatic relay optics, and the waveguide. Under the principles previously discussed the alignment of the image produces by the IIN with the waveguide may be used to ensure a quality image via the output grating. In many embodiments, the angle at which the image is projected from the IIN through the prismatic relay optics and subsequently to the waveguide display is maintained at an input angle configured for the particular optical characteristics desired such that total internal reflection is thus maintained. Therefore, the opto-mechanical coupler 354, in accordance with many embodiments, may be fabricated to accurately align the optical output of the IIN with the input grating of the waveguide at an input angle thus ensuring total internal reflection is maintained. Such alignment in accordance with some embodiments is thus illustrated in FIG. 27 by way of the mechanical design of the coupler with an optical window 376B and mechanical magnetic connection points 376A. Additional alignment methods are thus illustrated for example in FIGS. 40A-40F where the prismatic relay optics comprises a relatively flat component.

FIG. 28 illustrates an opto-mechanical coupling between the IIN and the waveguide component. In accordance with many embodiments, the IIN assembly 331 may also comprise a HDMI, DigiLens switch, power on/off switch and a photodiode PCB as generally indicated by 331B through 331E. As shown in FIG. 28 the IIN also comprises a microdisplay connector 377.

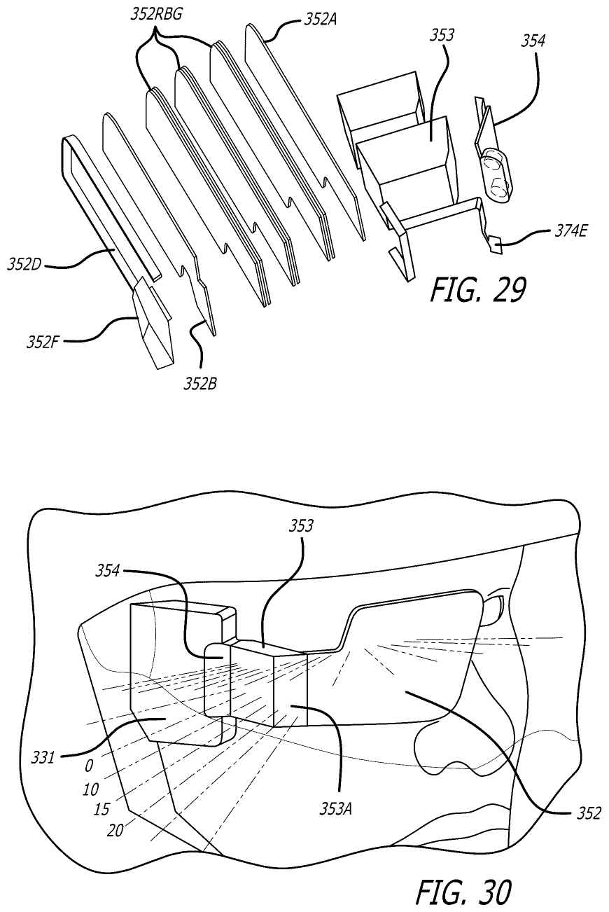

In accordance with many embodiments of the invention, FIG. 29 shows an exploded view detail of the HUD display without the IIN. The figure shows the waveguide eye piece 352, prismatic relay optics and coupler 353 and 354 respectively. The prism relay optics 353 provides a path linking the IIN to the waveguide eyepiece and due to its transparency also provides an enhanced peripheral field of view. The waveguide eyepiece, shown in exploded view, further comprises red, green and blue layers 352R, 352G, 352B encased between two layers of optical film 352A, 352B. Such film may consist of a polymer type material such that it provides wipe-clean, ballistic anti-shatter protection. Additionally, the optically sound waveguide eyepiece 352 may be encased by a clear surround molding 3352D. In accordance with many embodiments and to connect the power inputs of the IIN with that of the waveguide eyepiece components, a flex cable 374E may be used.

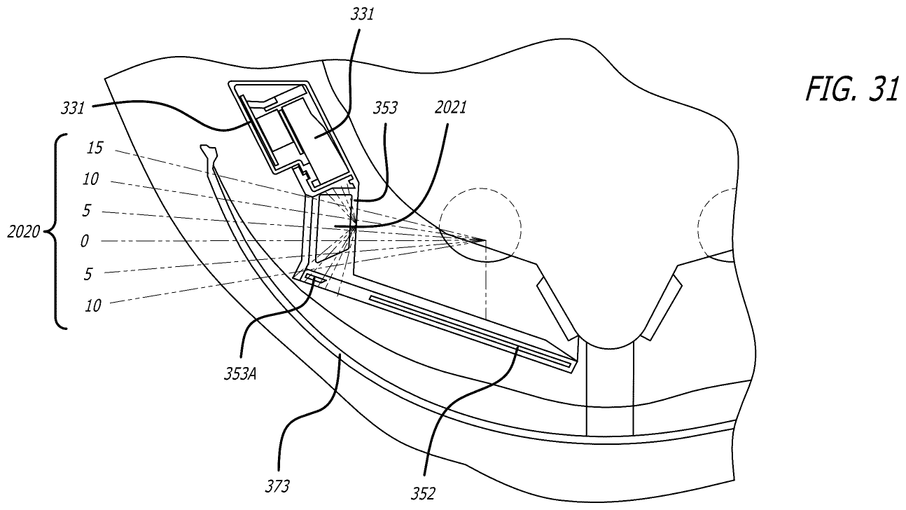

Turning now to FIG. 30 and in accordance with many embodiments an illustrative view of the HUD in a helmet is represented. FIG. 30 illustrates the HUD with the waveguide eyepiece 352 opto-mechanically connected to the prismatic relay optics 353 which opto-mechanically connect to the IIN 331 via an opto-mechanical coupling. Additionally, FIG. 30 illustrates the optimal field of view both horizontally and vertically with respect to the HUD when attached to a helmet, as illustrated via the blue and red degree lines. Maintaining adequate Field of View (FOV) angles is another element in the design of the prismatic relay optics. FIG. 31 further illustrates a preferred embodiment of the prismatic relay optics wherein the peripheral FOV is at least 25 degrees.

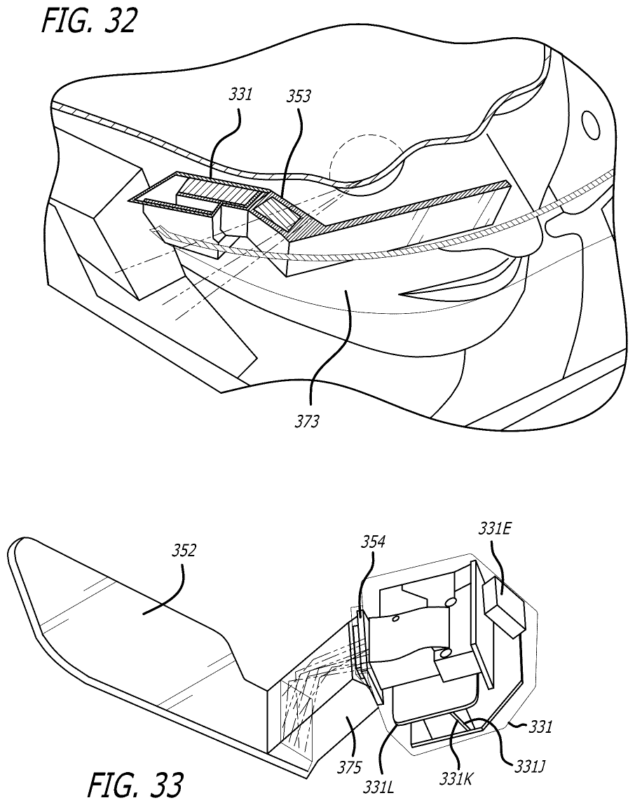

In accordance with many embodiments of the invention the IIN may comprise various optics and communications components. As illustrated in FIG. 33, many embodiments of the IIN may include a power switch 331L, various communication cables 331J, a cooling fan 331E, and other PCB components 331K that are electrically connected to the picoprojector and other optical components of the IIN. As described previously the IIN operates to generate an image and project the image through the prismatic relay optics at the preferred angle such that the image is ultimately displayed via the output gratings of the waveguide eyepiece.

Maintaining ideal temperatures of the electrical optical components may be implemented to ensure the waveguide eyepiece function. Therefore, in accordance with many embodiments a cooling fan 331E is illustrated in FIGS. 33-35. An exemplary fan for use with the invention is the model UF3A3-700manufactured by Sunonwealth Electric Machine Industry (China). The fan which has a volume of 10×10×3 mm provides an air flow of 3.43 liter/minute. The noise level is 21.0 dB (A)/30 cm. Using a cooling fan of this specification it is possible to meet current 40-degree thermal requirement specifications for motorcycle helmets.

Additionally, as illustrated in FIGS. 31-35 and 38-39, in many embodiments the components of the IIN assembly are collocated within a housing that facilitates the opto-mechanical coupling between the waveguide component and the IIN. In accordance with many embodiments the housing has a minimum wall thickness (e.g., less than 2 mm) to enhance the conduction heat away from the internal components. In many embodiments the IIN assembly may be integrated with the helmet itself or may be subsequently attached thereto.

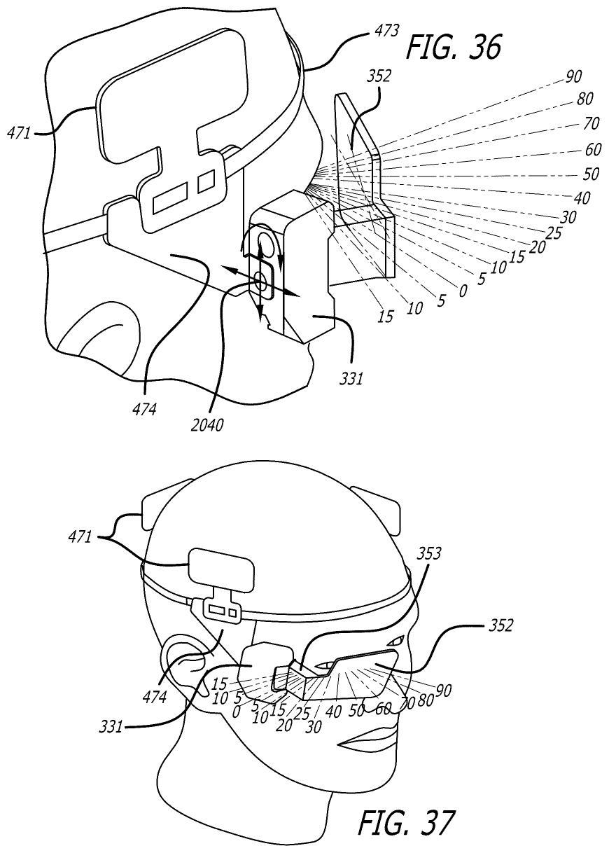

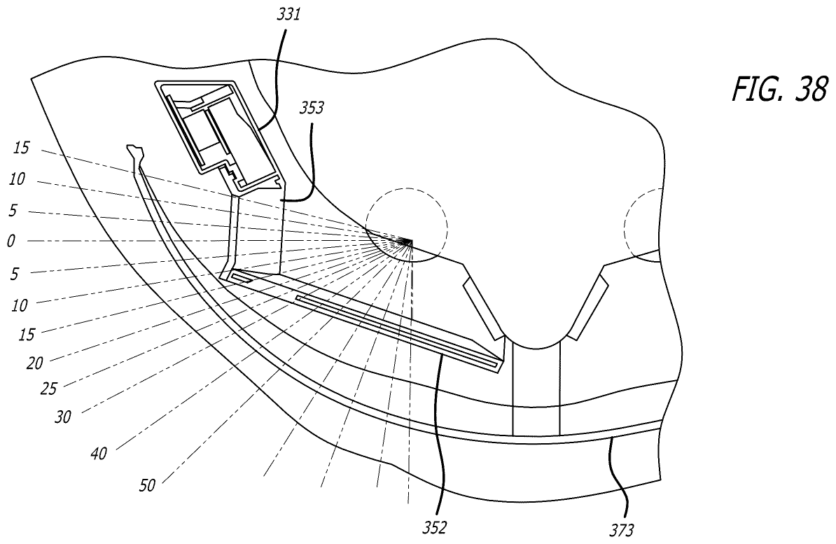

In accordance with many embodiments, a method of attaching the HUD unit to a helmet is presented. Turning to FIGS. 36 and 37 a method of attaching the HUD is illustrated. FIG. 36 illustrates the use of a supporting headband 473 that surrounds the users head and has a plurality of securing fixtures 471 attached thereto. The securing fixtures are configured to interconnect the supporting headband to the inside of a helmet. The securing fixtures may consist of a variety of devices including temporary hook and loop fasteners or more permanent type fasteners. The supporting headband is additionally configured to receive the HUD by way of an interconnection bracket. The interconnection bracket 474 may be configured to be adjustable along the length of the supporting headband 473 such that the position of the HUD can be adjusted to the most comfortable position of the user. Additionally, in accordance with many embodiments the interconnection bracket may be configured to allow multiple axis of adjustment 2040 of the HUD such that when the IIN connects thereto it would thereby allow the user to adjust the position of the HUD to maintain the greatest FOV. FIGS. 36 and 37 illustrate the desired FOV through the various adjustments positions of the HUD. Although a particular configuration is illustrated in FIGS. 36 and 37 it should be understood that any suitable configuration may be adopted. In accordance with many embodiments FIG. 38 illustrates a manner of configuration of the HUD integrated with a helmet such that the desired user FOV is maintained.

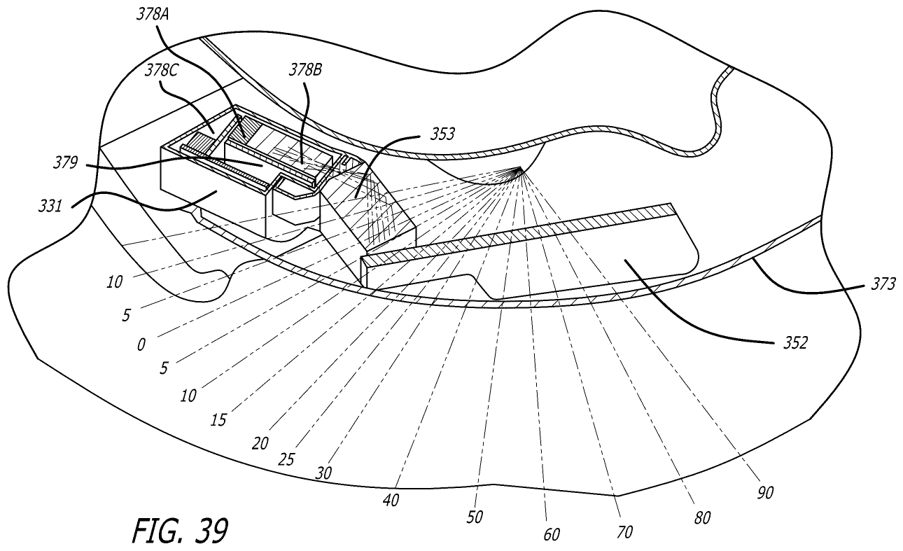

In accordance with many embodiments the IIN comprises a picoprojector group 378 as illustrated in FIG. 39 (other views are also illustrated in FIGS. 31-35). The picoprojector group may further comprise a first projection lens group 378A, a second lens group 378B for collimating the light reflected from the microdisplay 378C. Although not shown in the figures the picoprojector may further comprise an LED illuminator and LED illumination optics. In addition to the optical components, the IIN may further comprise an LED Heatsink 379 that may coordinate with the aforementioned fan to maintain the optimal thermal specifications. The IIN also comprises a microdisplay video controller PCB 377E. In some embodiments the IIN may contain separate rechargeable power cells for powering the various internal components. Ray paths through the projector are indicated by 2030 and in the prismatic relay element by 2031, thereby illustrating the projected optimal path of the image.

In accordance with many embodiments of the invention the HUD may be configured to be removable from a helmet configuration such that when not in use it may be properly stored and if applicable charged for future use. FIGS. 40A-40F illustrate an exemplary embodiment of the invention in which the IIN is configured to be removable from an electromechanical attachment point collocated in/on the helmet. In some embodiments the IIN may attach to the helmet via a magnetic connection. In other embodiments the connection may involve a variety of attachment configurations including a hinge or a USB type connection. Additionally, the IIN assembly may be configured with a communication port such that it may be in communication with other components of a helmet including Bluetooth connectivity and/or GPS. In other embodiments, although not illustrated in FIGS. 40A-40F, the attachment/detachment point may be between the waveguide component and the IIN. In such embodiments the waveguide component may be fully removed and properly stored when not in use.

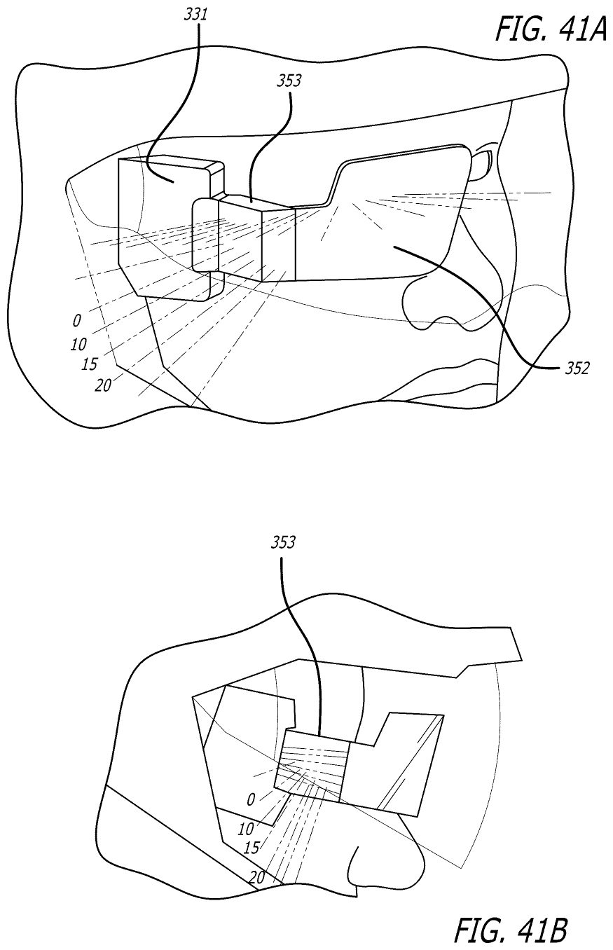

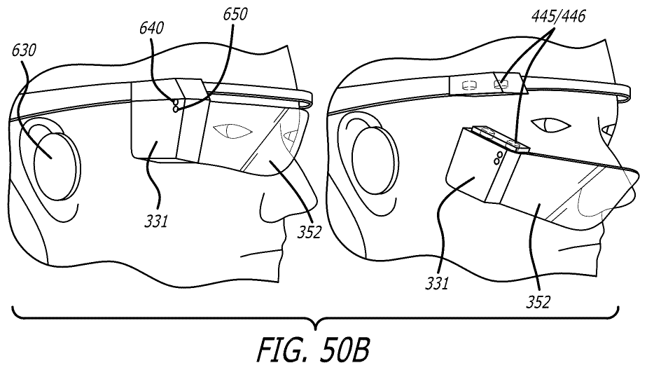

In accordance with many embodiments the prismatic relay optics 353 as illustrated in FIGS. 41A-41B, projects the beam from the pico projector located within the IIN 331. The beam will expand in the prism to allow for sufficient aperture to enable a high efficiency “Roll-K Vector” input aperture, thus preserving the efficiency and brightness of the projected image. The brightness of the image is also maintained through the various controllers in the IIN. For example, as illustrated in FIG. 50B, light and temperature sensors, 640 and 650 respectively, may be located within the IIN to accommodate for changes in ambient temperature and light.

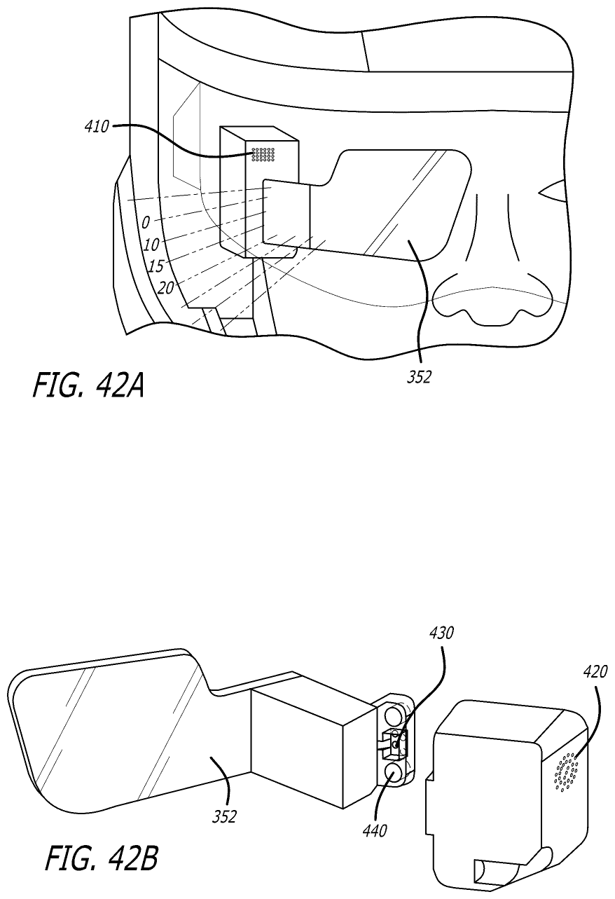

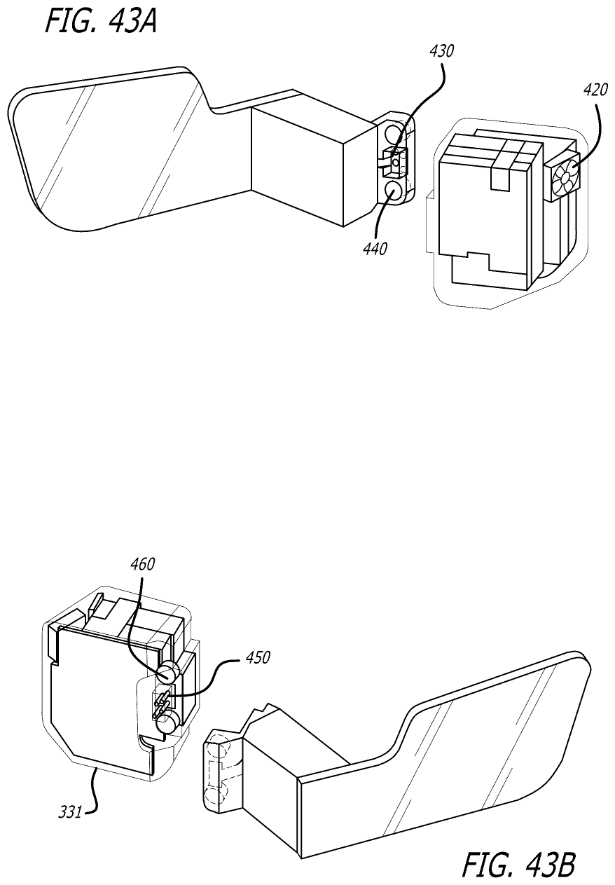

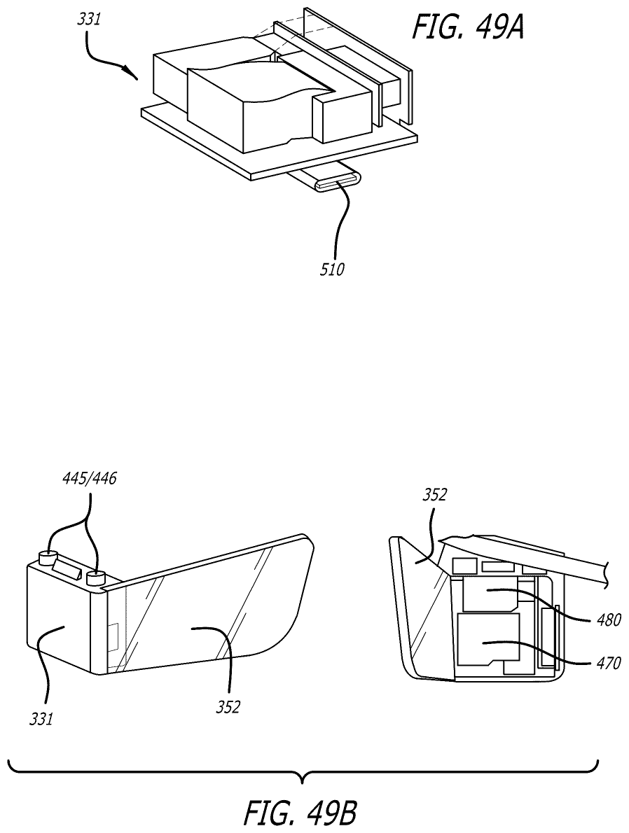

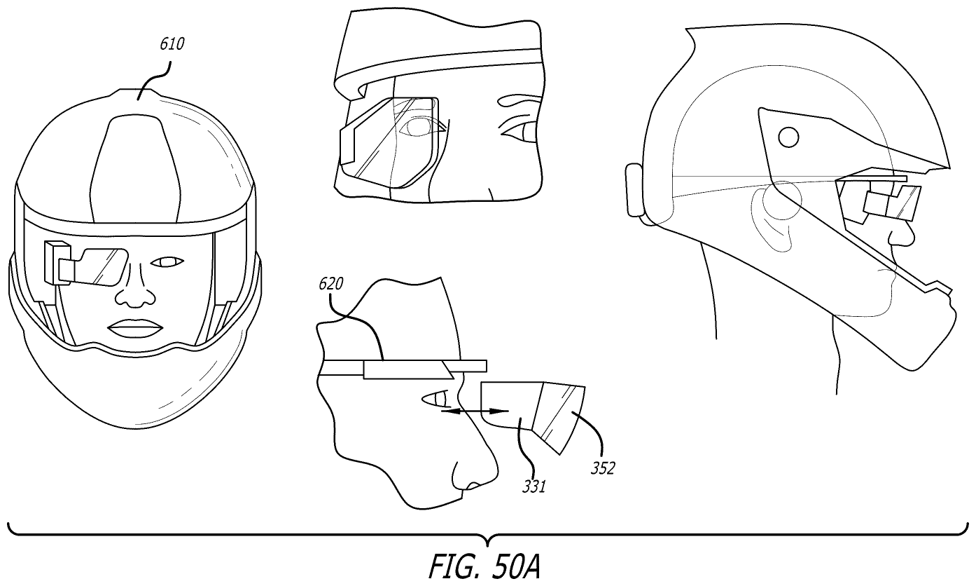

According to many embodiments the IIN 331, as mentioned previously also includes mechanisms such as fans and LED heatsinks that help to regulate the temperature to ensure the most efficient image production. FIG. 42A illustrates an ambient air intake 410 situated within the housing of the IIN. Additionally, FIG. 42B illustrates a conditioned air outtake 420 situated within the IIN housing. Furthermore, the IIN may include internal passive heat dissipation components 480 as illustrated in FIG. 49B. Such passive components may include fins or LED heatsinks as mentioned previously. Additionally, to ensure the most efficient image production the IIN and the opto-mechanical connection may include alignment magnets 440 and precision electrical connections 430. The electrical connections may, according to some embodiments, create the power connections between the various red, green, blue, or mono-color grating layers within the waveguide. Such connection may be configured to maintain an image quality from the IIN to the output grating. In accordance with many embodiments FIG. 43A illustrates the magnetic and electrical connections between the IIN and the prismatic relay.

FIG. 43B further illustrates the magnetic and electrical connections located within the IIN in accordance with some embodiments of the invention. Such connection may be one of several that exist on the IIN. The connection, in accordance with many embodiments of the invention may be configured to avoid a ghosting effect on the final image. Ghosting is spurious colors in the image due to inaccuracies in the individual waveguide light path (as created via the opto-mechanical connections) including glass flatness and can be affected by poor connections. Although specific embodiments of interconnection are shown, it will be understood that the electrical and alignment connections may take on any suitable form that produces a precise alignment.

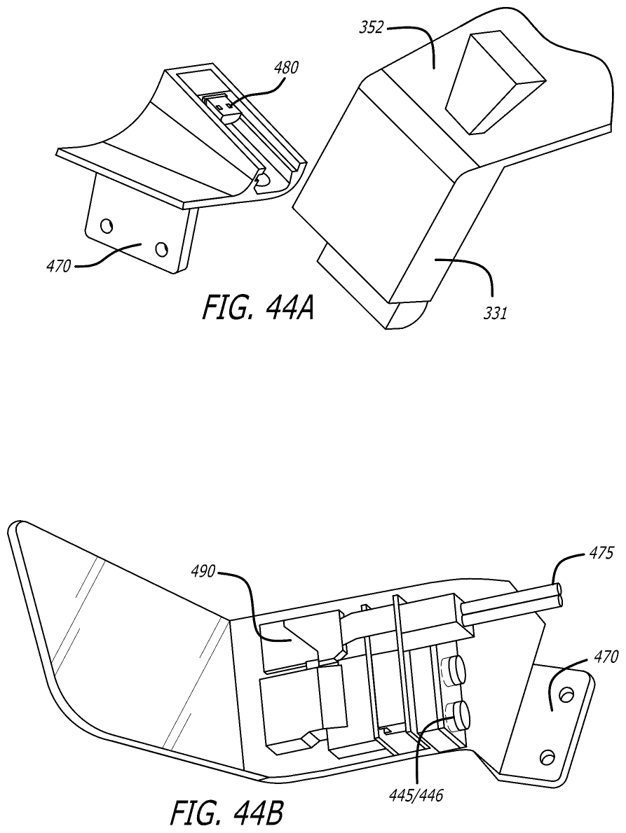

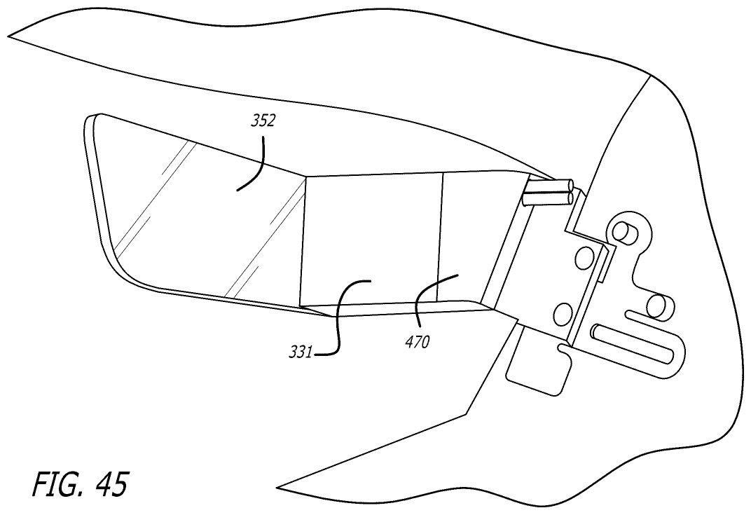

In accordance with many embodiments the HUD may be configured to mount on a helmet or other headpiece. As illustrated in FIGS. 44A-44B, one embodiment is shown where the power and other communication connections 480 are housed within a bracket 470. The bracket may have an alignment feature that correlates to a feature on the IIN such that the IIN securely aligns and connects to the helmet. Such connection may take on any number of forms and may include a magnetic connection 445/446 on either side of the connection. As further illustrated in FIG. 45 the alignment bracket 470 may be adjustable such that it can be configured to attach to any number of suitable head pieces or helmets.

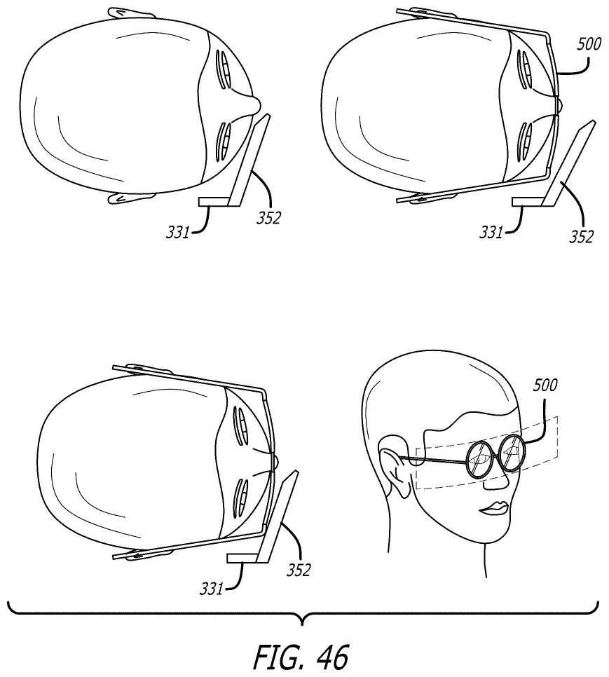

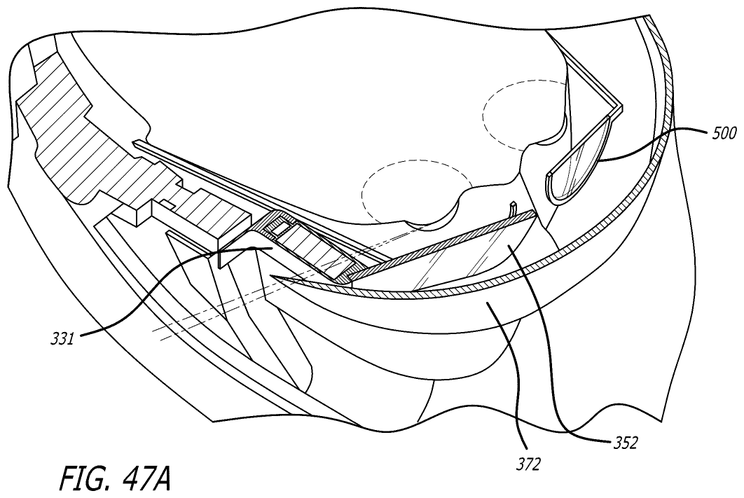

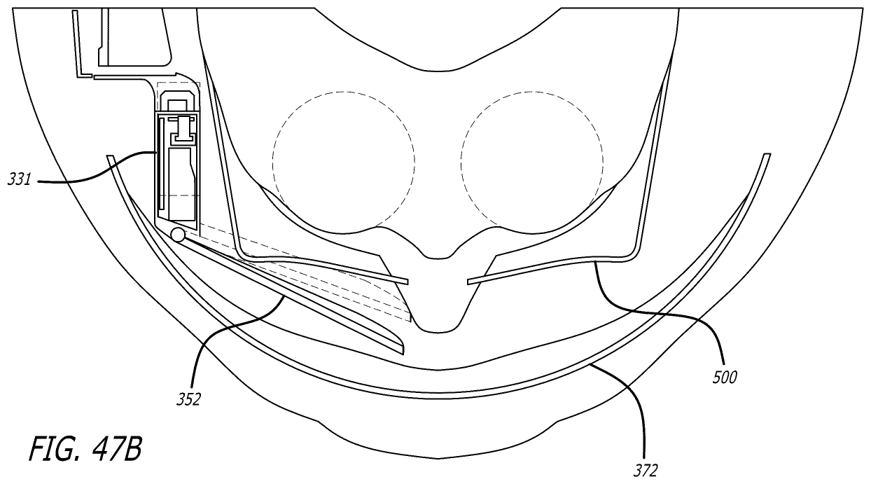

In accordance with many embodiments, as previously discussed, the HUD may be configured to be adjustable within the helmet or head piece. FIGS. 46-47B as well as FIGS. 36-38 illustrate embodiments of adjustable HUDs. In many embodiments the wearer may be wearing corrective lenses and thus would need to adjust the HUD accordingly so as not to interfere with the lenses and further provide the highest quality of image. As illustrated in FIG. 36 the attachment points may be fully adjustable. As illustrated in FIGS. 46-47B, the rake angle may be adjusted such that the HUD does not interfere with the corrective lenses as applicable. Additionally, as can be seen in FIGS. 47A-47B the waveguide 352 and the IIN 331 can be adjusted to not interfere with corrective lenses 500 or the internal face shield 372 of the helmet. In some embodiments the IIN can be adjusted horizontally (e.g., up to 10 mm) as needed. Additionally, in some embodiments the rake angle can be adjusted (e.g., to be within 25-28 degrees).

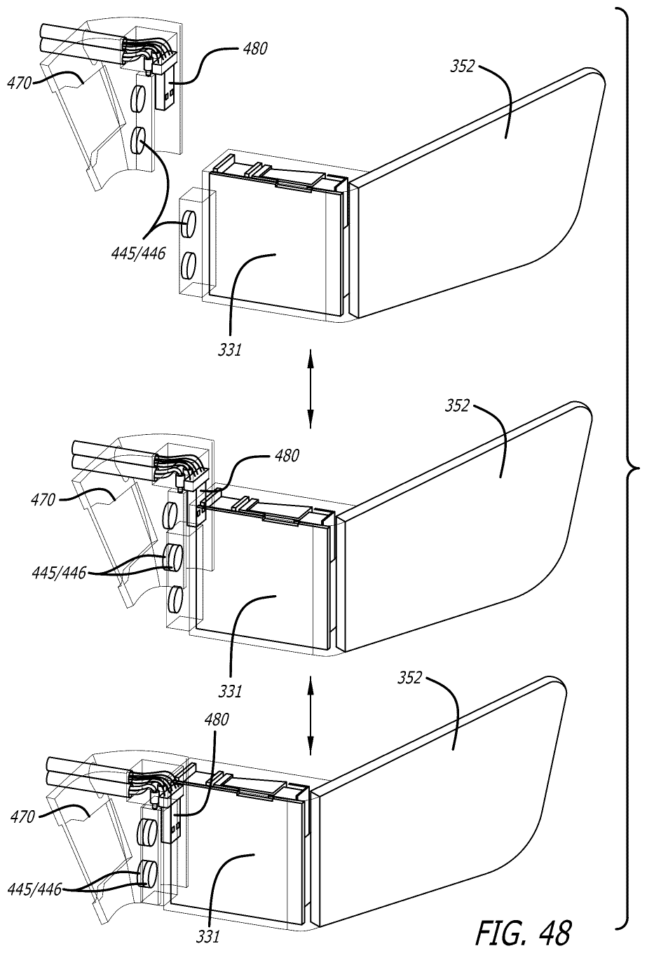

FIG. 48 in accordance with some embodiments of the invention illustrates the movement of the HUD with respect to the installation bracket of the desired headpiece. It should be understood that the bracket may take on any suitable form depending on the headpiece. According to many embodiments the bracket 470 and the IIN 331 may contain power cables and other communication connections such as HDMI or USB. For example, in some embodiments the IIN may contain a USB-C or other connection built within the PCB and other controllers, as shown in FIGS. 49A and 49B.

In accordance with some embodiments the HUD may be configured to attach to a head piece that may be retrofitted to a helmet or other device. As illustrated in FIGS. 50A and 50B, the HUD may connect to a headband that could be used while running or may be used as a retrofit to any helmet.

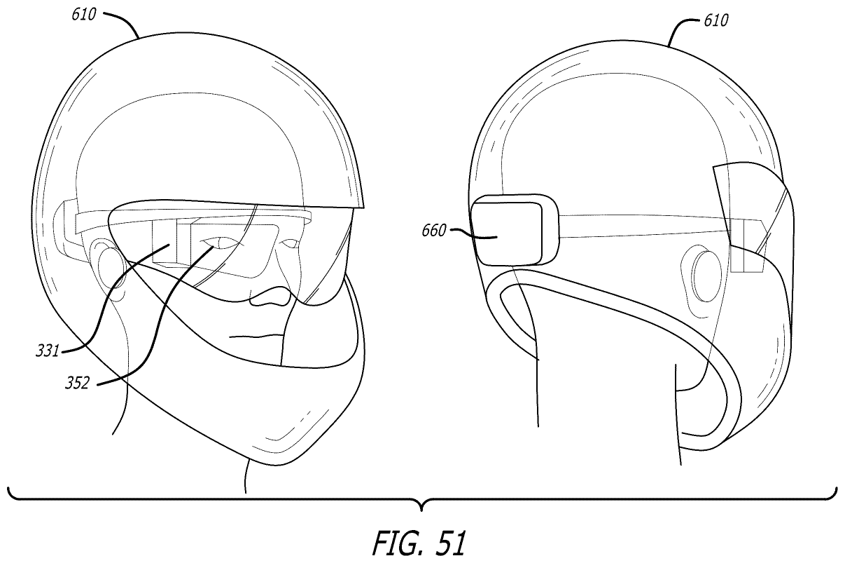

Because the IIN requires power to control the projectors and produce the image on the waveguide, many embodiments may include a separate power supply. As illustrated in FIG. 51, a separate power supply 600 unit may be located at the rear of the helmet or head piece. The power supply may contain electrical connections between the IIN and the power supply. Such connections may also be integrated within the headband or may be separate and routed through the internal portion of a helmet 610. Additionally, the power supply 600, being mobile, may be configured with a charging port such that it may be recharged as needed.

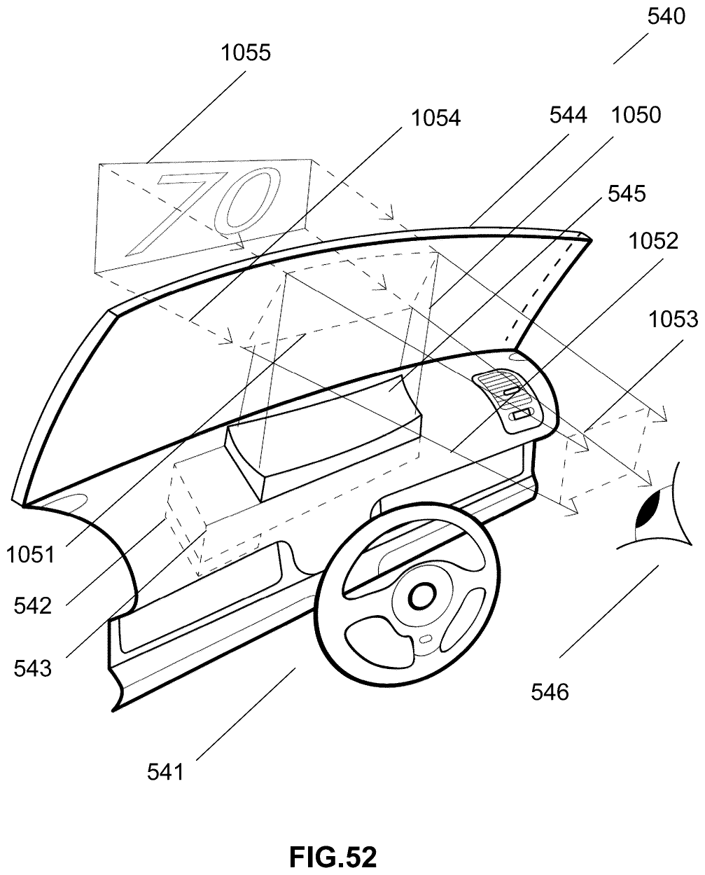

In some embodiments, a waveguide display according to the principles of the invention may provide a HUD for use in road vehicles in which image light is reflected off the windscreen into the driver's eye box. FIG. 52 is a schematic view of a waveguide display embodiment 540 for car HUD application with a correction element for compensating for windscreen curvature distortion in one embodiment. The optical display for configuration within a car interior 541 comprises the IIN 542, a waveguide 543 for projecting image light onto a windscreen 544 and a correction element 545 which has a prescription designed to balance the wavefront distortion of light reflected off the windscreen. In some embodiments, the correction element is a refractive element. In some embodiments, the correction element is a diffractive element. In some embodiments, the correction element is a plastic optical element. In some embodiments, the waveguide contains at least one birefringence compensation layers designed to balance the birefringence of a plastic correction element place in the path between the waveguide and the eye box. The light path from the waveguide to the eye via the reflection off the windscreen is illustrated by the rays 1050, 1052. The intersection of the image light with the windscreen and the eye box is indicated by 1051,1053. The virtual ray path 1054 up to the virtual image 1055 is also shown.

In some embodiments, a dual expansion waveguide display according to the principles of the invention may be integrated within a window, for example, a windscreen-integrated HUD for road vehicle applications. In some embodiments, a window-integrated display may be based on the embodiments and teachings disclosed in U.S. Provisional Patent Application No. 62/125,064 entitled OPTICAL WAVEGUIDE DISPLAYS FOR INTEGRATION IN WINDOWS and U.S. Provisional Patent Application No. 62/125,066 entitled OPTICAL WAVEGUIDE DISPLAYS FOR INTEGRATION IN WINDOWS, the disclosures of which are incorporated herein by reference. In some embodiments, a dual expansion waveguide display may include gradient index (GRIN) wave-guiding components for relaying image content between the IIN and the waveguide. Exemplary embodiments are disclosed in U.S. Provisional Patent Application No. 62/123,282 entitled NEAR EYE DISPLAY USING GRADIENT INDEX OPTICS and U.S. Provisional Patent Application No. 62/124,550 entitled WAVEGUIDE DISPLAY USING GRADIENT INDEX OPTICS, the disclosures of which are incorporated herein by reference. In some embodiments, a dual expansion waveguide display may incorporate a light pipe for providing beam expansion in one direction based on the embodiments disclosed in U.S. Provisional Patent Application No. 62/177,494 entitled WAVEGUIDE DEVICE INCORPORATING A LIGHT PIPE. In some embodiments, the input image source in the IIN may be a laser scanner as disclosed in U.S. Pat. No. 9,075,184 entitled COMPACT EDGE ILLUMINATED DIFFRACTIVE DISPLAY, the disclosures of which are incorporated herein by reference. The embodiments of the invention may be used in wide range of displays including HMDs for AR and VR, helmet mounted displays, projection displays, heads up displays (HUDs), Heads Down Displays, (HDDs), autostereoscopic displays and other 3D displays.

Some of the embodiments and teachings of this disclosure may be applied in waveguide sensors such as, for example, eye trackers, fingerprint scanners and LIDAR systems.

It should be emphasized that the drawings are exemplary in nature and even though particular embodiments are illustrated the design may take on any suitable configuration. Optical devices based on any of the above-described embodiments may be implemented using plastic substrates using the materials and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES, the disclosure of which is incorporated herein by reference. In some embodiments, the dual expansion waveguide display may be curved.

The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A waveguide display comprising:
an input image node (IIN) providing light of a first wavelength over an angular range;
a first waveguide comprising at least one input grating configured to couple light from the IIN into a total internal reflection (TIR) path in the first waveguide;
at least one grating for providing beam expansion in at least one direction and extracting light from the first waveguide; and
wherein a spatially varying numerical aperture for providing uniform illumination at an eyebox of the waveguide display is provided by tilting a stop plane containing an IIN exit pupil relative to an input grating plane containing the at least one input grating of the first waveguide.

2. The waveguide display of claim 1, wherein the at least one grating for providing beam expansion and extracting light from the first waveguide comprises at least one fold grating configured to provide pupil expansion in a first direction and at least one output grating configured to provide pupil expansion in a second direction different than the first direction and to cause the light to exit the first waveguide.

3. The waveguide display of claim 1, wherein the at least one input grating and/or the at least one grating is switchable between a diffracting state and a non-diffracting state.

4. The waveguide display of claim 1, further comprising a wavefront distortion compensation element.

5. The waveguide display of claim 1, wherein the spatially varying-numerical aperture is provided by tilting the stop plane such that its normal vector is aligned parallel to the highest display field angle in a field of view plane containing a field of view coordinate diffracted by the at least one input grating

6. The waveguide display of claim 1, further comprising at least one birefringence compensation layer.

7. The waveguide display of claim 1, further comprising a second waveguide, wherein:
the at least one input grating of the first waveguide is configured to couple first wavelength light; and
the second waveguide comprises at least one input grating configured to couple a second wavelength light from the IIN into a TIR path in the second waveguide and at least one grating for providing beam expansion in at least one direction and extracting the light from the second waveguide.

8. The waveguide display of claim 1, wherein the first waveguide is curved.

9. The waveguide display of claim 1, wherein the IIN comprises a spatial light modulator and a projection lens for projecting image modulated first wavelength light over an angular range.

10. The waveguide display of claim 1, wherein the IIN comprises a laser scanner for projecting image modulated first wavelength light over an angular range.

11. The waveguide display of claim 1, wherein the at least one input grating multiplexes at least one of color or angle or is a rolled k-vector grating.

12. The optical display of claim 1, wherein the at least one input grating comprises a grating selected from the group consisting of: a Bragg grating, a switchable Bragg grating, a grating recorded in a liquid crystal and polymer-based material, and a surface relief grating.

13. The optical display of claim 1, further comprising at least one of: an eye tracker, a despeckler, a dynamic focus lens disposed within said IIN, a dynamic focus lens disposed in proximity to one of the total internal refection surfaces of the first waveguide, a beam homogenizer, or at least one grating index image transfer waveguide portion.

14. The optical display of claim 1, wherein a spatially-varying numerical aperture component which forms a spatially varying numerical aperture across the angular range of the IIN to provide uniform illumination at an eyebox of the waveguide display is disposed within the IIN or in proximity to an output surface of the IIN.

15. The optical display of claim 14, wherein the spatially-varying numerical aperture component comprises a wedge lens, a curved wedge lens, an array of a plurality of prismatic elements having differing prism angles, or an array of lenses with various apertures and optical powers.

16. The optical display of claim 14, wherein the spatially-varying numerical aperture component comprises a scatter element integrated with a surface texture.

17. The optical display of claim 14, wherein the spatially-varying numerical aperture component comprises a substrate having varied scattering properties.

18. The optical display of claim 14, wherein the spatially-varying numerical aperture component comprises a birefringent substrate having a spatially varying birefringence

19. The optical display of claim 14, wherein the spatially-varying numerical aperture component is a thin substrate coated with a polymerized liquid crystals.

20. The optical display of claim 14, wherein the spatially-varying numerical aperture component is an array of diffractive elements each characterized by a unique K-vector and diffraction efficiency angular bandwidth.

21. The optical display of claim 14, wherein the spatially-varying numerical aperture component comprises a Bragg hologram recorded in a holographic polymer dispersed liquid crystal material.
